(19) United States
(12) Patent Application Publication
(10) Pub. No.: US 2023/0362494 A1
(43) Pub. Date: Nov. 9, 2023

(54) Photographic Strobe Inspection

(71) Applicant: The Boeing Company, Chicago, IL (US)

(72) Inventors: Jeremiah Scott, Kirkland, WA (US); Jennifer E. Reitz, Woodinville, WA (US); Daniel E. Sutherland, Federal Way, WA (US)

(21) Appl. No.: 17/814,125

(22) Filed: Jul. 21, 2022

Related U.S. Application Data
(60) Provisional application No. 63/364,323, filed on May 6, 2022.

(51) Int. Cl. H04N 5/235; G06T 7/00; H04N 5/225; B64F 5/60

(52) U.S. Cl. CPC H04N 5/2354; H04N 5/2353; G06T 7/001; H04N 5/2256; B64F 5/60; G06T 2207/20212; G06T 2207/10152; G06T 2207/30108; B64C 1/12

(57) ABSTRACT

A method, an apparatus, and a system for inspecting a surface. An image capture system adjusts at least one of an aperture or a shutter speed to result in capturing a black image when an image of a surface is captured with the surface illuminated only by an ambient light.

The image capture system captures an incident angled flash illuminated image of the surface to create a first image. The image capture system captures an opposed incident angled flash illuminated image of the surface to create a second image. The first image and the second image are combined to form an inspectable image with a width of at least one frame pitch. The inspectable image is inspected.

This application claims the benefit of priority of provisional U.S. Patent Application Ser. No. 63/364,323, entitled “Photographic Strobe Inspection”, filed on May 6, 2022, which is hereby incorporated by reference.

### BACKGROUND INFORMATION

### 1. Field

The present disclosure relates generally to inspecting structures and in particular, to inspecting structures using strobe light.

### 2. Background

Nondestructive inspection (NDI) techniques are used to test, inspect, or evaluate a structure without destroying structure. Nondestructive inspection can employ a number of different inspection techniques to identify properties of the structure. These properties can be used to test and inspect components, identify anomalies in an object, perform quality control, for failure analysis, and other suitable purposes. For example, nondestructive inspection techniques can include, for example, magnetic particle testing, ultrasonic testing, electromagnetic testing, radiographic testing, liquid penetrant testing, and visual testing. Some of these testing techniques can be used to identify anomalies internally in an object while others can be used to detect anomalies on the surface of an object.

When nondestructive inspection is performed with visual testing, characteristics such as surface integrity of an object can be determined by visually examining the surface of the structure. The visual examination can be performed by human operator using handheld light and viewing the surface to determine whether inconsistencies are present in the surface of the object. This visual examination can also be made by generating images and having the human operator review the images for the presence of inconsistencies on the surface of the object.

### SUMMARY

An embodiment of the present disclosure provides a method for inspecting a surface. An image capture system adjusts at least one of an aperture or a shutter speed to result in capturing a black image when an image of a surface is captured with the surface illuminated only by an ambient light. The image capture system captures an incident angled flash illuminated image of the surface to create a first image. The image capture system captures an opposed incident angled flash illuminated image of the surface to create a second image. The first image and the second image are combined to form an inspectable image with a width of at least one frame pitch. The inspectable image is inspected.

Another embodiment of the present disclosure provides a method for inspecting a surface of an object. A set of strobe lights is aligned to emit a set of flashes at a set of angles of incidence relative to the surface to be inspected. An image capture system is set to capture flash only illuminated images of an area on the surface illuminated by a set of synchronized flashes emitted at the area on the surface with the set angles of incidence by the set of strobe lights. The image capture system captures a set of flash only illuminated images of the surface illuminated by the set of flashes. An inspectable image is created using the set of flash only illuminated images.

Yet another embodiment of the present disclosure provides a method for inspecting a surface of an aircraft fuselage of an aircraft. A set of strobe lights in a strobe light system is aligned to emit synchronized flashes at an area of the surface of the aircraft fuselage. The area has a width that is at least at a multiple or fraction of a frame pitch. An image capture system progressively captures images of the surface for successive areas relative to the frame pitch. The images captured by the image capture system are inspected.

Still another embodiment of the present disclosure provides a method for inspecting a surface of an object. A set of synchronized flashes is emitted at an area on the surface at an angle of incidence relative to the surface. An image capture system captures a set of flash only illuminated images of the area on the surface illuminated only by the set of synchronized flashes emitted at the area on the surface at the angle of incidence. The set of flash only illuminated images of the area on the surface captured by the image capture system is inspected to determine whether an inconsistency is present in the area on the surface.

A further embodiment of the present disclosure provides a surface inspection system comprising a strobe light system, an image capture system, and a controller. The controller is configured to control the strobe light system to emit a set of synchronized flashes from a strobe light system at an area on the surface at an angle of incidence relative to the surface. The controller is configured to control the image capture system to capture a set of flash only illuminated images of the area on the surface illuminated only by the set of synchronized flashes emitted at the area on the surface at the angle of incidence. The controller is configured to inspect the set of flash only illuminated images of the area on the surface captured by the image capture system to determine whether an inconsistency is present in the area on the surface.

Yet another embodiment of the present disclosure provides a surface inspection system. The surface inspection system comprises a strobe light and an image capture system. The strobe light is positioned relative to an area on a surface of an object. The strobe light emits a flash at the area on a surface of the object at an angle of incidence relative to the surface, wherein the angle of incidence is selected based on a type of inconsistency to be detected. The image capture system is positioned such that the flash is captured perpendicular to the area. The image capture system captures a flash only illuminated image of the area on the surface that is only illuminated by the flash emitted from the strobe light to the area on the surface at the angle of incidence.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an inspection environment in accordance with an illustrative embodiment;

FIG. 2 is an illustration of directional lighting using a strobe flash from a strobe light in accordance with an illustrative embodiment;

FIG. 3 is an illustration of a diagram of strobe positions for inspecting a surface in accordance with an illustrative embodiment;

FIG. 4 is an illustration of strobe lights positioned to emit flashes on a contoured surface in accordance with an illustrative embodiment;

FIG. 5 is an illustration of a strobe light system using opposing positions to inspect a surface in accordance with an illustrative embodiment;

FIG. 6 is an illustration of images generated for a surface of an object in accordance with an illustrative embodiment;

FIG. 7A-7B are an illustration of images of a surface in accordance with an illustrative embodiment;

FIG. 8 is an illustration of a surface inspection system in accordance with an illustrative embodiment;

FIG. 9 is an illustration of a surface inspection station for inspecting fuselage sections in an assembly line process in accordance with an illustrative embodiment;

FIG. 10 is an illustration of a surface inspection system for inspecting objects in accordance with an illustrative embodiment;

FIG. 11 is an illustration of a flowchart of a process for inspecting the surface of an object in accordance with an illustrative embodiment;

FIG. 12 is an illustration of a flowchart of a process for inspecting a surface in accordance with an illustrative embodiment;

FIG. 13 is an illustration of a flowchart of a process for inspecting a surface for a fuselage of an aircraft in accordance with an illustrative embodiment;

FIG. 14 is an illustration of a flowchart of a process for inspecting a surface for a fuselage of an aircraft in accordance with an illustrative embodiment;

FIG. 15 is an illustration of a flowchart of a process for capturing a black image of the surface in accordance with an illustrative embodiment;

FIG. 16 is an illustration of a flowchart of a process for aligning synchronized flashes in accordance with an illustrative embodiment;

FIG. 17 is an illustration of a flowchart of a process for aligning a set of strobe lights in accordance with an illustrative embodiment;

FIG. 18 is an illustration of a flowchart of a process for aligning sets of strobe lights in accordance with an illustrative embodiment;

FIG. 19 is an illustration of a flowchart of a process for inspecting a surface in accordance with an illustrative embodiment;

FIG. 20 is an illustration of a flowchart of a process for combining images in accordance with an illustrative embodiment;

FIG. 21 is an illustration of a flowchart of a process for inspecting a surface of an object in accordance with an illustrative embodiment;

FIG. 22 is an illustration of a flowchart of a process for adjusting a set of camera settings in accordance with an illustrative embodiment;

FIG. 23 is an illustration of a flowchart of a process for aligning strobe lights in accordance with an illustrative embodiment;

FIG. 24 is an illustration of a flowchart of a process for capturing images in accordance with an illustrative embodiment;

FIG. 25 is an illustration of a flowchart of a process for setting a power level of strobe lights in accordance with an illustrative embodiment;

FIG. 26 is an illustration of a flowchart of a process for combining images in accordance with an illustrative embodiment;

FIG. 27 is an illustration of a flowchart of a process for aligning a set of strobe lights in accordance with an illustrative embodiment;

FIG. 28 is an illustration of a flowchart of a process for creating an isolated light source in accordance with an illustrative embodiment;

FIG. 29 is an illustration of a flowchart of a process for moving the surface inspection system in accordance with an illustrative embodiment;

FIG. 30 is an illustration of a flowchart of a process for manually inspecting images in accordance with an illustrative embodiment;

FIG. 31 is an illustration of a flowchart of a process for automatically inspecting images in accordance with an illustrative embodiment;

FIG. 32 is an illustration of a flowchart of a process for inspecting a surface of an aircraft fuselage in accordance with an illustrative embodiment;

FIG. 33 is an illustration of a flowchart of a process for moving a surface inspection system in accordance with an illustrative embodiment;

FIG. 34 is an illustration of a flowchart of a process for moving an aircraft fuselage in accordance with an illustrative embodiment;

FIG. 35 is an illustration of a flowchart of a process for inspecting a surface of an object in accordance with an illustrative embodiment;

FIG. 36 is an illustration of a flowchart of a process for emitting synchronized flashes from a strobe light system in accordance with an illustrative embodiment;

FIG. 37 is an illustration of a flowchart of a process for inspecting a surface of an object in accordance with an illustrative embodiment;

FIG. 38 is an illustration of a flowchart of a process for emitting synchronized flashes in accordance with an illustrative embodiment;

FIG. 39 is an illustration of a flowchart of a process for capturing flash only illuminated images in accordance with an illustrative embodiment;

FIG. 40 is an illustration of a flowchart of a process for placing a flag in accordance with an illustrative embodiment;

FIG. 41 is an illustration of a block diagram of an aircraft manufacturing and service method in accordance with an illustrative embodiment;

FIG. 42 is an illustration of a block diagram of an aircraft in which an illustrative embodiment may be implemented; and

FIG. 43 is an illustration of a block diagram of a product management system in accordance with an illustrative embodiment.

### DETAILED DESCRIPTION

The illustrative embodiments recognize and take into account one or more different considerations as described herein. For example, current visual inspection methods relying on the inspections performed by a human operator can deliver inconsistent detection of inconsistencies in a structure. A human operator can miss inconsistencies when not looking in the right location, not having the right angle of light, and other factors further, human factors such as fatigue and visual acuity of each individual human operator can influence the effectiveness of a visual inspection. Inconsistent lighting levels around the inspection area can affect the success rate of visual inspections. Increasing the luminance of the light in inspection area can be helpful but is not always viable depending on the location and configuration of tools and restrictions in the inspection area.

Further, and yet lighting often does not provide sufficient directional detail to differentiate surface anomalies from the background. As result, generating images and even using software to inspect images can result in missing anomalies using current lighting systems and analysis systems and processes.

Therefore, it would be desirable to have a method and apparatus that take into account at least some of the issues discussed above, as well as other possible issues. For example, it would be desirable to have a method and apparatus that overcome a technical problem with at least one of human operators perform inspections or the use of ambient light and performing inspections.

It is typically undesirable to change the angle of incidence during surface inspection. These changes can make machine learning difficult to employ if the angle of incidence changes during inspections.

However, in the illustrative examples, changes to the angle of incidence can occur depending on the type of inspection if the inspection is to detect hair line cracks or other small features, then the angle of incidence can be set to 80 degrees. If the type of inspection is to inspect for anomalies that may be larger and more easily perceivable, then the angle of incidence can be decreased to 60 degrees.

Thus, the illustrative examples can change the angle of incidence used to direct light at the surface depending on the type of inconsistency that is to be detected. In the illustrative examples, these images can be taken by an image capture device such as a camera. The image capture device can be set in a manner such images captured of the surface are only illuminated by the flash and without the ambient light.

Further, quantifying or measuring surface anomalies can be performed using measurement systems when human operator where to apply those systems. However, these measurements cannot be made without knowing that surface anomalies are present and where the surface anomolies are located. The illustrative examples can use strobe light systems to locate those surface anomalies over larger areas to ensure that the anomalies can be consistently detected. This capability in the illustrative examples can allows measurements to taken and applied where they are needed so that surface anomalies are not missed. As a result, the occurrence costly rework and safety issues discovered later in the build process or after delivery can be reduce using the strobe inspection in system in the illustrative examples.

Thus, illustrative examples provide a method, apparatus, system, and computer program product for inspecting the surface of the structure using strobe lights. Photographic capture of an object using strobe lights can be used to detect inconsistencies in the surface of a structure. The photographic capture of images using strobe lights can enable the separation ambient lighting from flashes emitted from the strobe lighting.

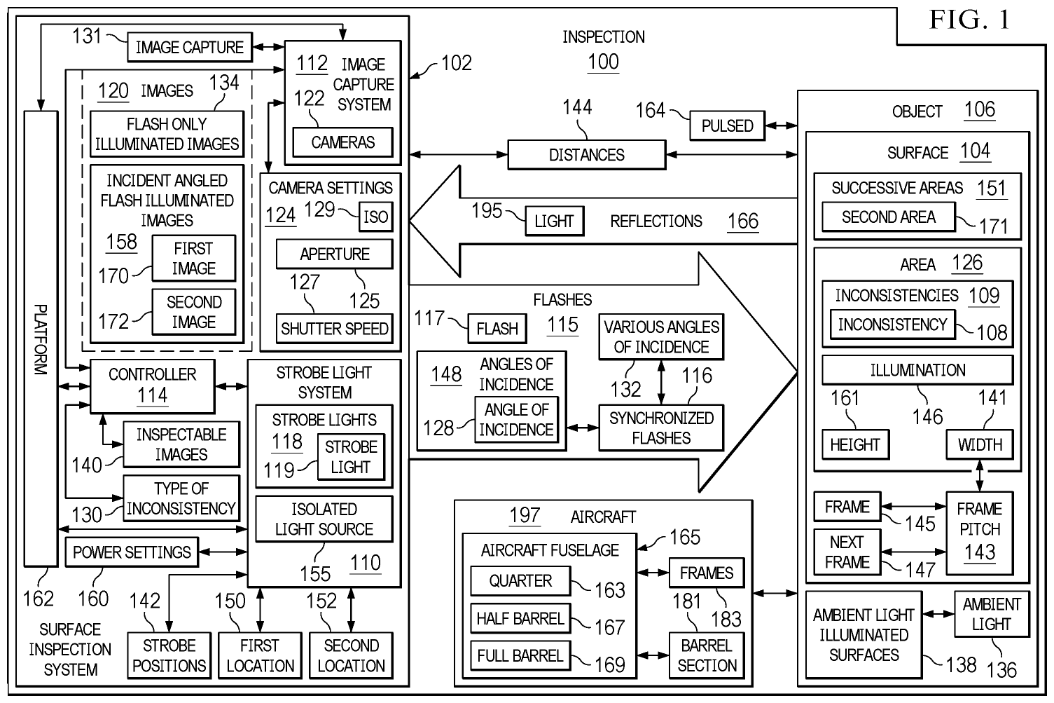

With reference now to the figures and in particular with reference to FIG. 1, an illustration of a block diagram of an inspection environment is depicted in accordance with an illustrative embodiment. Inspection environment 100 is an environment in which surface inspection system 102 can perform an inspection of surface 104 of object 106. Object 106 can take a number of different forms. For example, object 106 can be selected from the group comprising a fuselage section, quarter barrel, half barrel, a full barrel, a fuselage, a wing, an aircraft, a vehicle, a train, a spacecraft, a bus, a wall, and other suitable objects. This inspection can be formed to detect the presence of inconsistency 108 on surface 104 of object 106. Inconsistency 108 can be selected from a group comprising dust, a dent, a crack, debris, a delamination, a missing fastener, and other suitable types of anomalies. In this example, inconsistency 108 can be part of a set of inconsistencies 109. In this illustrative example, inconsistencies 109 can be selected from at least one of dust, a dent, an inward dent, an outward dent, a protrusion, a crack, debris, a delamination, a missing fastener, a fastener installed out of tolerance, or other inconsistencies that may be located on or near surface 104.

Inspection can be performed for area 126. In this example, area 126 can have width 141, which can be a fraction or multiple of frame pitch 143. In this example, frame pitch 143 can be a distance from a centerline of frame 145 to a center line of next frame 147 in object 106.

Area 126 can have height 161. When object 106 is aircraft 197, height 161 can be quarter 163, of aircraft fuselage 165, half barrel 167, and full barrel 169 of aircraft fuselage 165, which are examples of barrel section 181 in aircraft fuselage 165 defined by frames 183 in aircraft fuselage 165. In this example, quarter 163 can be a panel for aircraft fuselage 165.

In this example, surface inspection system 102 can inspect successive areas 151 in addition to area 126 to determine whether a set of inconsistencies 109 may be present in successive areas 151. For example, second area 171 in successive areas 151 can be inspected after area 126. Images 120 of these successive areas can be progressively captured by capture system 112. In this illustrative example, successive areas 151 can be relative to frame pitch 143. With this inspection, at least one of platform 162 or object 106 can be moved to present successive areas 151 for inspection.

In this illustrative example, surface inspection system 102 comprises a number of different components. As depicted, surface inspection system 102 can comprise strobe light system 110, image capture system 112, and controller 114.

Strobe light system 110 is a physical system comprising strobe lights 118 that can emit a set of flashes 115. As used herein, a “set of” when used with reference items means one or more items. For example, a set of flashes 115 is one or more of flashes 115.

Strobe light system 110 can emit flashes 115 in the form of synchronized flashes 116. In this illustrative example, synchronized flashes 116 are flashes 115 that can occur or operate at the same time or rate. In this illustrative example, synchronized flashes 116 are synchronized with the capturing of images 120 by image capture system 112. In other words, the synchronization occurs in a manner that image capture system 112 captures an image while a set of synchronized flashes 116 illuminates area 126. In other words, capturing, image capture system 112 captures a set of flash only illuminated images of area 126 on surface 104 illuminated only by the set of synchronized flashes 116 emitted at area 126 on surface 104 at angle of incidence 128 in which image capture system 112 uses a shutter speed that is synchronized within the duration of the set of synchronized flashes 116 in area 126 such that strobe light system 110 is an isolated light source 155.

In this example, image capture system 112 captures the set of images 120 in a position perpendicular to the area 126 of surface 104.

In this illustrative example, strobe light system 110 is comprised of a set of strobe lights 118. A strobe light is a device that can generate a flash or burst of light such as a flash in flashes 115. A strobe light can produce a continuous series of short bright flashes of light.

For example, a strobe light can produce a light having a flash energy from about 10 J to about 150 J. For example, the duration of the strobe light generated can be from about 0.5 μs to about 5.6 ms. The flash power can be several kilowatts. The strobe light source can be implemented using, for example, a xenon flash lamp. Power settings 160 of a set of strobe lights 118 can be adjusted to change illumination 146 of area 126. With this example, different strobe lights in strobe lights 118 can have the same or different power setting.

In this illustrative example, changing the power setting to increase the light output level of strobe light 119 in the set of strobe lights 118 can provide increased inspection area when emitting flash 117 in flashes 115. The method for increased inspection area can be based on inverse square law, which states of an effect such as illumination changes in inverse proportion to the square of the distance from the source.

Strobe lights 118 have strobe positions 142 relative to area 126 on surface 104. In this illustrative example, strobe position in strobe positions 142 is a three-dimensional location of a strobe light. The strobe position for a strobe light can also include an orientation for the strobe light. Strobe positions 142 can have distances 144 from area 126.

Strobe positions 142 of strobe lights 118 can have orientations selected to obtain desired values for angles of incidence 148 for strobe lights 118. Additionally, strobe positions 142 can be changed to change distances 144 from strobe lights 118 to area 126 to adjust the amount of illumination 146 of area 126 in addition to or in place of angles of incidence 148.

For example, distances 144 can be decreased to increase illumination 146 of area 126 by synchronized flashes 116. Distances 144 can be increased to reduce illumination 146 of area 126 by synchronized flashes 116. Increasing distances 144 can result in synchronized flashes 116 can be more diffused.

The addition of a Fresnel lens in front of a strobe light can be used in situations the strobe light is located further away from area 126. The Fresnel lens can support a focused light source and with additional strobe power, can support a larger inspection area for area 126.

With distances 144 for strobe lights 118 being reduced, an increased amount of area 126 can be illuminated by synchronized flashes 116. For example, synchronized from strobe light 118 can have a range of 22 to 24 inches depending on the particular type of synchronized light used.

In one illustrative example, a first set of strobe lights 118 can be positioned to emit synchronized flashes 116 at area 126 on surface 104 with angle of incidence 128 and a second set of strobe lights 118 can be positioned to emit a number of synchronized flashes 116 at area 126 from first location 150 relative to surface 104 with angle of incidence 128 from second location 152 relative to surface 104 with angle of incidence 128. In this manner, illumination of 146 of area 126 can be performed from different locations increasing an ability to detect a presence of inconsistency 108 on surface 104 in area 126. Light 195 in reflections 166 from illumination 146 of area 126 of surface 104 are captured to form images 120.

In one illustrative example, first location 150 is opposite to second location 152. With this example, strobe light system 110 emits a first number of synchronized flashes 116 in the set of synchronized flashes 116 at the area on the surface in a first direction at the angle of incidence 128 relative to the surface from the first location 150. A second number of synchronized flashes 116 in the set of synchronized flashes 116 is emitted by strobe light system 110 at area 126 on surface 104 in a second direction at angle of incidence 128 relative to surface 104 from a second location 152. In this example, the second direction is opposite to the first direction. In other words, the second direction can be in a direction that is 180 degrees from the first direction.

In other illustrative examples, strobe positions 142 can be selected such that strobe lights 118 emit synchronized flashes 116 with various angles of incidence 148. For example, a first number of a set of strobe lights 118 can emit a first number of a set of synchronized flashes 116 using a first angle of incidence while a second number of a set of strobe lights 118 can emit a second number of a set of synchronized flashes 116 using a second angle of incidence. In yet another illustrative example, different strobe lights in a set of strobe lights can have different angles of incidence. In other illustrative examples, additional numbers of strobe lights 118 can be positioned in other locations to direct synchronized flashes 116 at area 126 from different directions at area 126.

In this illustrative example, image capture system 112 is a hardware system and comprises a set of cameras 122. In this illustrative example, a camera in the set of cameras 122 is a physical optical device that captures an image from light detected. In this illustrative example, the camera includes a digital sensor and various components that control how light is captured by the digital sensor.

In this illustrative example, camera settings 124 can be controlled for image capture system 112. Examples of camera settings 124 include at least one of aperture 125, shutter speed 127, ISO 129, or other suitable settings. In this illustrative example, the aperture and shutter speed can be adjusted to control exposure. Aperture 125 is the opening size and can be described as f-stops. ISO 129 also can be used to increase or decrease how much light it takes to capture the details of an image. Reducing ISO 129 can also reduce capturing ambient light 136. Thus, in this example, in camera settings 124 at least one of aperture 125, shutter speed 127, or ISO 129 can be selected such that image capture system 112 captures the set of images 120 using only the set of synchronized flashes 116 without ambient light 136.

For example, shutter speed 127 can be set from about 1/160 of a second to about 1/250 of a second can be used to capture flash only illuminated images 134 of area 126 of surface 104 illuminated by the set of flashes 115 and not capturing ambient light illuminated surfaces 138. In other words, image capture 131 of ambient light illuminated surfaces 138 is blocked image capture of ambient light illuminated surfaces 138, which can be caused by increasing the speed of shutter speed 127. Also, image capture 131 of ambient light illuminated surfaces 138 is blocked image capture of ambient light illuminated surfaces 138, which can be caused by restricting or reducing the size of aperture 125. In yet another example, image capture 131 of ambient light illuminated surfaces 138 is blocked image capture of ambient light illuminated surfaces 138 can be caused by reducing ISO 129.

In the depicted example, shutter speed 127 can be considered a main control. Aperture 125 and ISO 129 can be secondary controls in controller capture of ambient light 136.

In this manner, an isolated light source can be created that separates ambient light 136 from reflections 166 of flashes 115 from area 126 of surface 104. Ambient light 136 can originate from be shop lights or other light sources in the environment other than strobe lights 118.

The use of strobe lights 118 to emit synchronized flashes 116 results in synchronized flashes 116 overpowering ambient light 136 for the short duration of the available exposure time. By using sufficiently high shutter speeds, the capture of ambient light illuminated surfaces 138 is avoided. Further, synchronized flashes 116 emitted from strobe lights 118 provide light directionality not present with ambient light 136. As result, synchronized flashes 116 provide improved illumination of inconsistency 108 as compared to ambient light 136.

In this illustrative example, controller 114 can control the operation of at least one of strobe light system 110 or image capture system 112. As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Controller 114 can be implemented in software, hardware, firmware or a combination thereof. When software is used, the operations performed by controller 114 can be implemented in program code configured to run on hardware, such as a processor unit. When firmware is used, the operations performed by controller 114 can be implemented in program code and data and stored in persistent memory to run on a processor unit. When hardware is employed, the hardware can include circuits that operate to perform the operations in controller 114.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

In operation, controller 114 can cause strobe light system 110 to emit a set of synchronized flashes 116 at area 126 on surface 104 of object 106. The set of synchronized flashes 116 are emitted at an angle of incidence 128 relative to surface 104. In this illustrative example, angle of incidence 128 can be selected based on type of inconsistency 130 to be detected when performing the inspection.

For example, the set of synchronized flashes 116 can be emitted from strobe light system 110 at area 126 on surface 104 at angle of incidence 128 relative to surface 104 that is from about 60 degrees to about 80 degrees. In this illustrative example, angle of incidence 128 selected to decrease as the size of inconsistency 108 to be detected increases. Angle of incidence 128 selected to increase as the size of inconsistency 108 to be detected decreases.

Further, controller 114 can control how image capture system 112 captures images 120 of area 126 on surface 104 of object 106. In this illustrative example, controller 114 can control camera settings 124 for capture system 112 to have sensors in cameras 122 in capture system 112 only capture reflections 166 of synchronized flashes 116 from strobe lights 118 and not ambient light 136.

For example, controller 114 can control capture system 112 to capture images 120 of area 126 of surface 104 that is only illuminated by the set of synchronized flashes 116 emitted at area 126 on surface 104. In this example, these types of images 120 are flash only illuminated images 134.

In this illustrative example, flash only illuminated images 134 does not include capturing not ambient light 136. In other words, the image captures performed such image capture 131 of ambient light illuminated surfaces 138 by image capture system 112 is blocked from capture by sensors generating images 120 in image capture system 112 to form flash only illuminated images 134. For example, the shutter opens only long enough for strobe lights 118 to illuminate area 126, but not long enough for ambient light 136 to illuminate anything in the same span of time. Strobe lights 118 are fired and fully illuminate the area 126 while ambient light 136 does not have enough time to illuminate the sensor with enough light required to generate any image. In this example, the shutter speed to capture images 120 is selected to avoid capturing ambient light 136.

In one illustrative example, controller 114 can also cause strobe light system 110 to emit the set of synchronized flashes 116 at area 126 on surface 104 at a set of various angles of incidence 132 relative to surface 104 in addition to angle of incidence 128 relative to surface 104. In other words, synchronized flashes 116 can be emitted at two or more different angles of incidence 148. For example, various angles of incidence 132 are selected from a group comprising 80 degrees for at least one of hair line cracks or dust and 60 degrees for a dent.

With strobe light system 110 emitting synchronized flashes 116 at one or more angles of incidence 148, images 120 captured by image capture system 112 take the form of incident angled flash illuminated images 158. With these types of images, the image capture of ambient light illuminated surfaces 138 in images 120 can be blocked through at least one of camera settings 124 for image capture system 112, a set of strobe positions 142 for strobe lights 118, or a set of power settings 160 for a set of strobe lights 118.

In emitting synchronized flashes 116 from strobe light system 110, a first number of the set of synchronized flashes 116 can be emitted from the strobe light system at angle of incidence 128 relative to the surface 104. Image capture system 112 captures first image 170 in incident angled flash illuminated images 158 while area 126 is illuminated by the first set of synchronized flashes 116.

Next, a second number of the set of synchronized flashes 116 is emitted from strobe light system 110 at angle of incidence 128 relative to surface 104 after emitting the first number of synchronized flashes 116 and the capture of first image 170. Second image 172 in incident angled flash illuminated images 158 is captured while the second number of the set of synchronized flashes 116 illuminates area 126 of surface 104.

In this illustrative example, controller 114 can inspect flash only illuminated images 134 of area 126 captured by image capture system 112. This inspection can be performed to determine whether inconsistency 108 is present in area 126 of surface 104. Inconsistency 108 can be in tolerance or out of tolerance. When inconsistency 108 is in tolerance, rework of the tolerance or discarding the part is unnecessary. When inconsistency 108 is out of tolerance, rework may be needed or the part may be discarded.

In this illustrative example, the inspection can be performed on incident angled flash illuminated images 158. This inspection can be performed directly on these images or from processing the images prior to inspection. This processing can include combining incident angled flash illuminated images 158 to create inspectable images 140.

In this illustrative example, surface inspection system 102 can also include platform 162. Platform 162 provides a structure for connecting and holding components. As depicted, strobe light system 110 and image capture system 112 are connected to platform 162.

In some illustrative examples, platform 162 can move strobe light system 110 and image capture system 112 relative to object 106 to inspect other areas on surface 104 of object 106. In another illustrative example, object 106 can be moved relative to platform 162. With this example, the movement of object 106 can be pulsed 164.

In this example, pulsing means that object 106 is moved and stopped for a period of time. During the period of time while object 106 is stationary, strobe light system 110 can perform different operations to capture images 120, such as incident angled flash illuminated images 158. In this example, each pulse can result in movement of object 106 from one area to another area for inspection by surface inspection system 102. These areas can have a width that is selected from a frame pitch, a panel width, a width of a half barrel, a width of a full barrel, or some other width.

In one illustrative example, one or more technical solutions are present that overcome a technical problem with inspecting surfaces of objects. In one or more illustrative examples, inconsistencies can be detecting by capturing images in an area of a surface of an object using flashes to illuminate the area of a surface to be inspected. The flashes are directed towards the area with an angle of incidence that can be selected based on the type of inconsistency to be detected. In illustrative examples, images can be taken from various angles of incidence for inspection. This type of lighting surfaces and capturing of images of the surfaces various angles of incidence can provide images that are more consistent and easier to inspect in determining whether inconsistencies are present on the surface of the object.

Thus, the different illustrative examples can employ one or more angles of incidence when illuminating a surface using a strobe light system. This type of illumination can enable capturing images where the inconsistencies are better highlighted by the incident angled direct and sharp illumination by flashes emitted at one or more angles of incidence. This type of image capture using angled flashes can increase the appearance of shadows that are more defined and make the inconsistencies easier to detect in images.

Additionally, the angle incidence lighting increases the contrast of the image illuminating high points or placing low points in deep shadow, especially when opposing strobe illuminated images are used in a combined image after successive opposite illuminated captured images are combined. By capturing images from flashes emitted at the area for inspection from different locations relative to the area being inspected, inconsistencies that do not have a consistent shape can be highlighted and shadowed such that the combination is stronger in one direction than the other. As a result, by placing strobe lights in locations such that the flashes are opposing directions, further enhancement of inconsistencies can be achieved when capturing images of the area. This combination can be made by capturing images from each direction and combining the images to form an inspectable image.

The illustration of inspection environment 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, inspection environment 100 can include other components not shown or depicted. In one illustrative example, object 106 can be a fuselage section carried on a line assembly system along a track or rail system in the line assembly system.

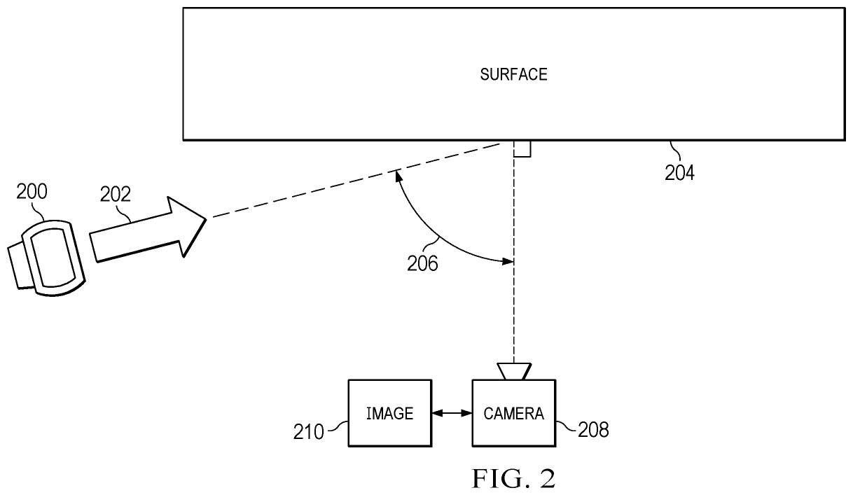

Turning next to FIG. 2, an illustration of directional lighting using a strobe flash from a strobe light is depicted in accordance with an illustrative embodiment. In this illustrative example, strobe light 200 can emit flash 202 at surface 204. In this example, flash 202 is emitted at angle of incidence 206 relative to surface 204. As depicted, camera 208 is positioned perpendicular to surface 204. Angle of incidence 206 can be selected to enable faster effective detection of inconsistencies such as dust, a dent, an inward dent, and outward dent, a protrusion, a crack, debris, a delamination, a missing fastener, a fastener installed out of tolerance, and inconsistencies that may be located on or near surface 204. Camera 208 can capture image 210. This image can be inspected to determine whether inconsistency is present on surface 204. In some illustrative examples, angle of incidence 206 may not be as important and can be omitted in selecting the position of strobe light 200.

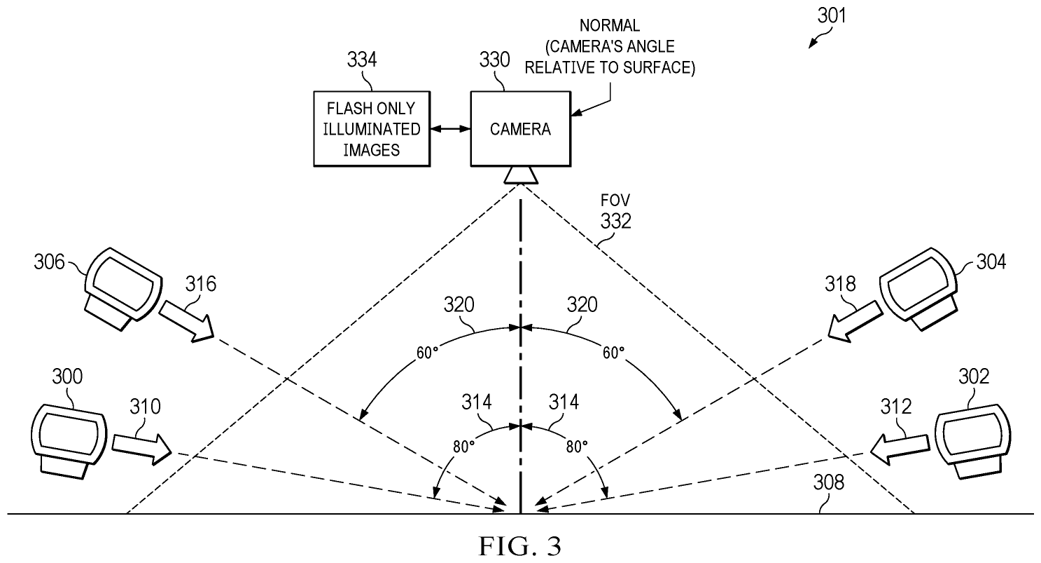

With reference next to FIG. 3, an illustration of a diagram of strobe positions for inspecting a surface is depicted in accordance with an illustrative embodiment. In this illustrative example, strobe light system 301 comprises strobe light 300, strobe light 302, strobe light 304, and strobe light 306 positioned to emit flashes at surface 308.

In this example, strobe light 300 emits flash 310 and strobe light 302 emits flash 312 from positions that have angle of incidence 314 that is 80 degrees. As depicted, strobe light 306 emits flash 316 and strobe light 304 emits flash 318 having angle of incidence 320 that is 60 degrees.

In this example, camera 330 is positioned normal or perpendicular to surface 308. Camera 330 has field-of-view (FOV) 332 for capturing images of surface 308 as illuminated by flashes. In these illustrative examples, these strobe lights emit synchronized flashes. The synchronization of flashes can be synchronized with camera 330 to capture flash only illuminated images 334 of flashes reflected off surface 308.

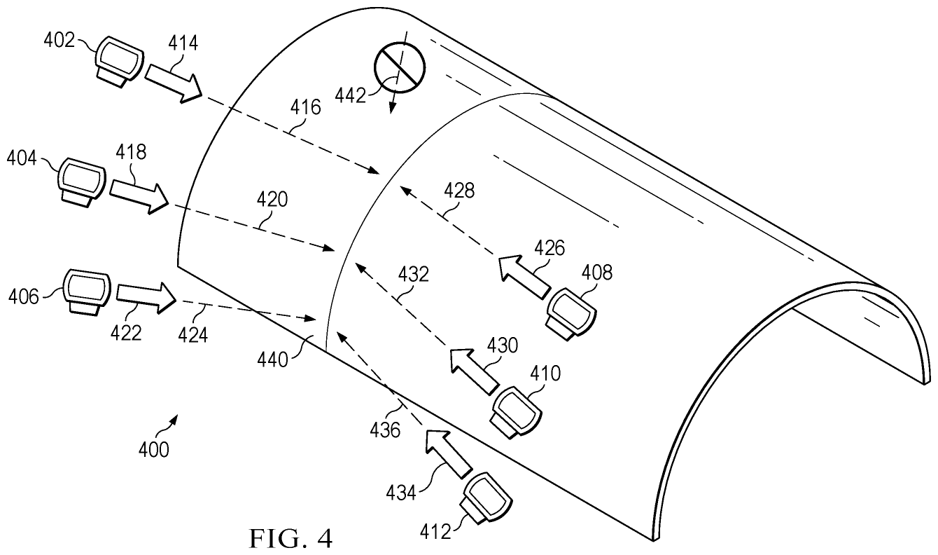

With reference now to FIG. 4, an illustration of strobe lights positioned to emit flashes on a contoured surface is depicted in accordance with an illustrative embodiment. In this illustrative example, strobe light system 400 comprises strobe light 402, strobe light 404, strobe light 406, strobe light 408, strobe light 410, and strobe lights 412.

As depicted, strobe light 402 emits flash 414 in direction 416, strobe light 404 emits flash 418 in direction 420, and strobe light 406 emits flash 422 in direction 424. Further, strobe light 408 emits flash 426 in direction 428, strobe light 408 emits flash 430 in direction 432, and strobe light 408 emits flash 434 in direction 436.

In this illustrative example, the surface of the object is curved surface 440. Each strobe light is positioned to direct a flash that lies in a plane perpendicular to curved surface 440 and intersecting curved surface 440 along a straight line or path. In this example, the light from the flashes travels in a direction that is normal to curved surface 440 and not against the curve. For example, direction 442 is an improper direction in this example. These directions can be characterized as being parallel to a line of inflection on which curved surface 440 curves.

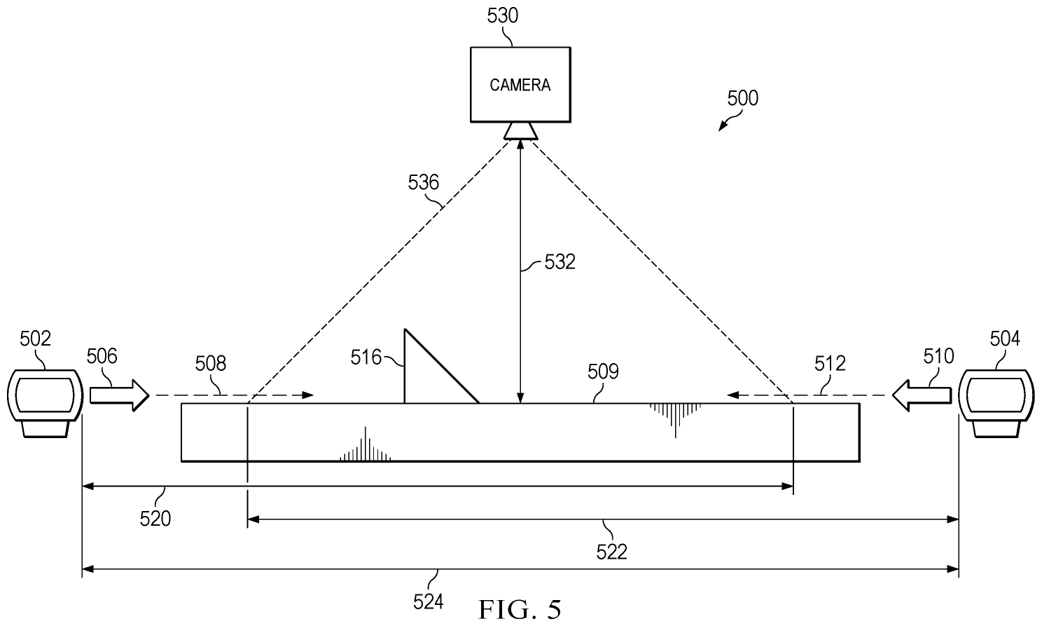

With reference to FIG. 5, an illustration of a strobe light system using opposing positions to inspect a surface is depicted in accordance with an illustrative embodiment. As depicted, strobe light system 500 comprises strobe light 502 and second strobe light 504. Strobe light 502 is positioned to emit flash 506 in first direction 508 with respect to surface 509. Second strobe light 504 is positioned to emit second flash 510 in second direction 512 with respect to surface 509.

In this example, second direction 512 is an opposite direction of first direction 508. In other words, second direction 512 can be 180 degrees as compared to first direction 508 at 0 degrees. In this illustrative example, inconsistency 516 is located on surface 509. Flash 506 and second flash 510 illuminate inconsistency 516 from opposite directions in this example.

In this example, a first image can be captured after the emission of flash 506. A second image can be captured after the emission of second flash 510. This type of configuration for strobe light system 500 can take into account that inconsistencies may not have a constant curvature. As result, the highlight and shadow combination may be stronger in one direction than another direction. In other words, using opposing strobe lights and strobe light system 500 can make it easier to detect inconsistency 516 from first direction 508 as compared to second direction 512. As a result, using strobe light 502 and second strobe light 504 aligned opposite to each other to inspect the same area can further enhance an ability to detect inconsistency 516 on surface 509.

For example, when inconsistency 516 protrudes above 509, strobe light 502 and second strobe light 504, an image in which inconsistency 516 is seen as being brighter as compared to other portions in which inconsistency 516 is absent. If inconsistency 516 is a depression in surface 509, then inconsistency 516 can be seen as a shadow or darker region in the image. In other words, the incident angled flashes of the strobe light illuminate the high spots above surface 509 being inspected and cast deep shadows in the low spots relative to surface 509 being inspected.

In this illustrative example, strobe light 502 can illuminate distance 520, and second strobe light 504 can illuminate distance 522. In this illustrative example, distance 520 and distance 522 are about 22 to about 24 inches. As depicted, distance 524 between strobe light 502 and second strobe light 504 is about 44 to about 48 inches.

In this illustrative example, increasing the power level of strobe light 502 and second strobe light 504 can provide an increased inspection area of surface 509, assuming that strobe light 502 and second strobe light 504 can be positioned in a manner such that flash 506 and second flash 510 are emitted parallel to a contour of surface 509.

For example, if strobe light 502 and second strobe light 504 has about 80 watt seconds as the unit of energy for the duration per second, an effective illumination area can be 11 feet from strobe light 502 and second strobe light 504. In this example, the effective inspection area is about 2 feet to about 8 feet from strobe light 502 and second strobe light 504. In other words, distance 520 can be 11 feet and distance 522 can be about 2 feet to about 4 feet.

If the power is changed to 160 Watt seconds, the effective illumination area is about 16.5 feet. As result, the inspection area can be about 4 feet to about 12 feet from each strobe light. As result, distance 520 in distance 522 can each be about 4 feet to about 12 feet. Although the distance is increased, a decrease of the area on the strobe side can occur. As a result, an inspection range can be increased by increasing a strobe power for the set of strobe lights.

In this example, distance 520 and distance 522 can be determined using inverse square law. Using this law, the intensity of illumination changes in inverse proportion to the square of the distance from the source.

As depicted, camera 530 is positioned distance 532 from surface 509. Distance 532 is about 3 feet. In this illustrative example, distance 532 of camera 530 from surface 509 to be inspected is related to the resolution of camera 530 in desired value for field of view 536. Field-of-view 536 can become wider to cover a larger area of surface 509. However, image quality can be limited by the amount of illumination delivered to surface 509. Further, a smaller value for field-of-view 536 can result images of a smaller area with a higher resolution. The smaller field-of-view can be used to take into account the amount of illumination provided by strobe light 502 and second strobe light 504.

With this illumination of surface 509, camera 530 can capture images of surface 509. As depicted, strobe light 502 emits flash 506 and second strobe light 504 emits second flash 510. These flashes are synchronized flashes that are synchronized with the capturing images by camera 530. In other words, the flashes are emitted and camera 530 captures images during the illumination of surface 509 by the flashes.

For example, strobe light 502 emits flash 506. Camera 530 captures a first image during the emission of flash 506. Next, second strobe light 504 emits second flash 510. Camera 530 captures a second image during the emission of second flash 510.

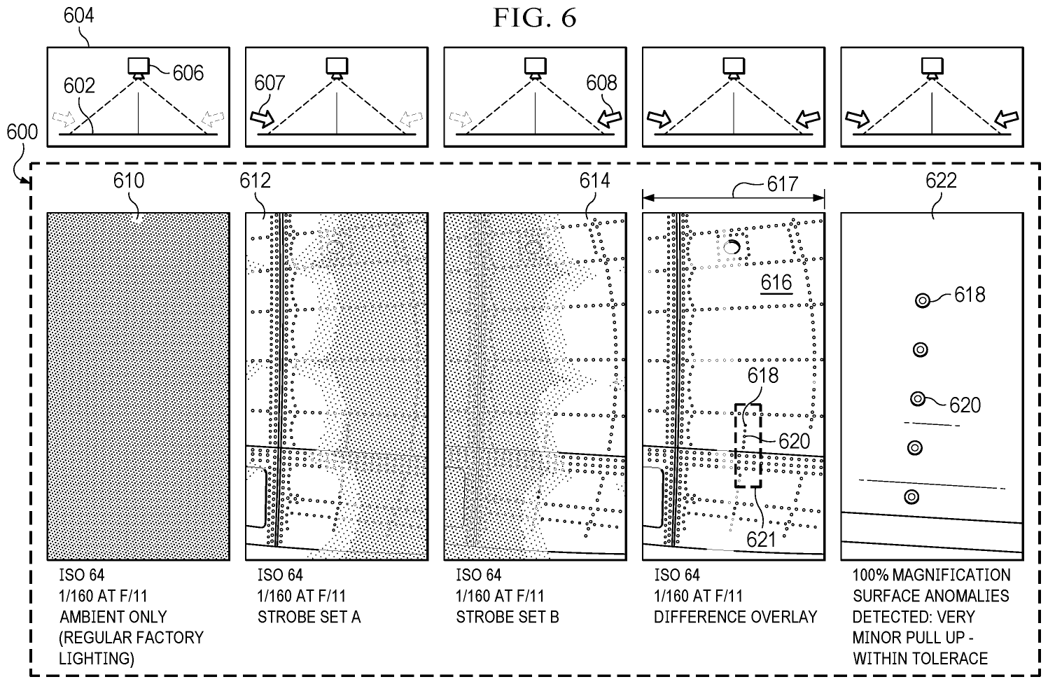

Turning to FIG. 6, an illustration of images generated for the surface of an object is depicted in accordance with an illustrative embodiment. As depicted, images 600 images of surface 602 generated by surface inspection system 604. The settings for camera 606 in surface inspection system 604 are ISO 64, shutter speed 1/160 with a F-stop of F/11.

As depicted, black image 610 is without emitting a flash. Only ambient in light is present when black image 610 is generated. In this illustrative example, black image 610 verifies that camera 606 does not detect ambient light with the current settings. In other words, image capture of ambient light illuminated surfaces. In this example, blocking ambient light is verified by black image 610.

First image 612 is captured by camera 606 using flash 607. First image 612 is an incident angled flash illuminated image of surface 602. Second image 614 is captured by camera 606 using flash 608 which is emitted in the opposite direction from flash 607. Second image 614 is also an incident angled flash illuminated image of surface 602.

Next, inspectable image 616 is formed from combining first image 612 with second image 614. This combination can be for using a difference filter that takes the intensity and color values from first image 612 and second image 614 and subtract those values from each other. The combination can be performed after image capture is performed. In this example, the combination of first image 612 with second image 614 forms inspectable image 616. Inspectable image 616 provides an ability to more easily identify inconsistency 618 and inconsistency 620.

In this illustrative example, inspected image 616 has width 617 of at least one frame pitch. In the illustrative example, with 617 can be a multiple or fraction of the frame pitch.

As depicted, image 622 is an enlarged view of section 621 in inspectable image 616. In this illustrative example, inconsistency 618 and inconsistency 620 are in tolerance fasteners.

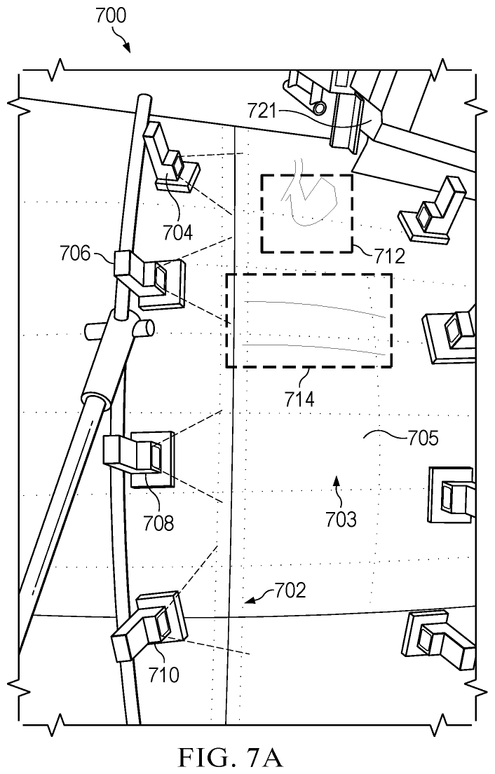

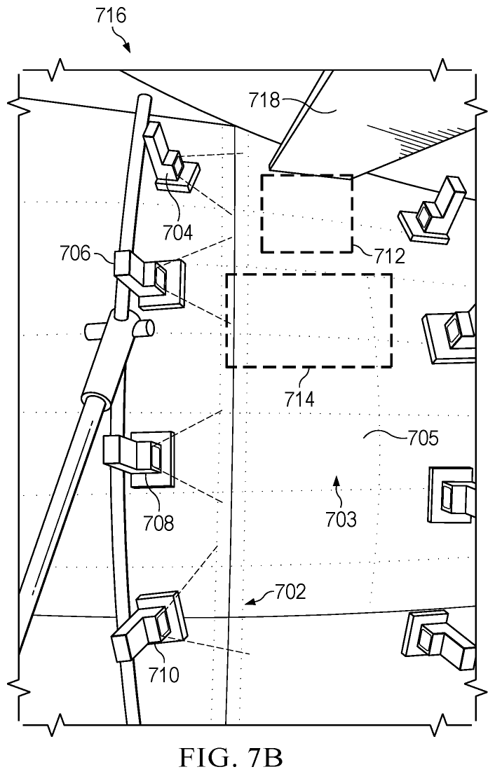

With reference next to FIGS. 7A-73, an illustration of images of a surface is depicted in accordance with an illustrative embodiment. In this illustrative example, image 700 illustrates the capture of surface 702 with flashes emitted from strobe light 704, strobe light 706, strobe light 708, and strobe light 710. These strobe lights are emitted into area 703 at surface 705.

In image 700, undesired reflections from flashes are present on surface 702. For example, undesired reflections from flashes bouncing off nearby reflective surfaces can be seen in section 712 and section 714 of image 700.

Flags can be used to block extraneous light reflections caused by flashes bouncing off nearby reflective surfaces. As depicted in image 716 of surface 702, flag 718 is present in the same view of surface 702. Flag 718 blocks out undesired reflections of flashes bouncing off nearby reflective surfaces. For example, flag 718 can block reflection of the set of synchronize flashes from further reflecting off another surface 721 and back into area 703. In other words, flag 718 blocks a reflection of a flash from further reflecting off another surface and back into the area on surface 702 being inspected. This result can be seen in section 712 and section 714 in image 716. Undesired reflections are no longer present in the sections with the use of flag 718.

In the illustrative example, flag 718 can take a number of different forms. For example, flag 718 can be a black cloth, a nonreflective structure, or other types of light blockers. As a result, the strategic placement of flag 718 and potentially other flags can be used to eliminate undesirable reflections of flashes from surfaces to be inspected.

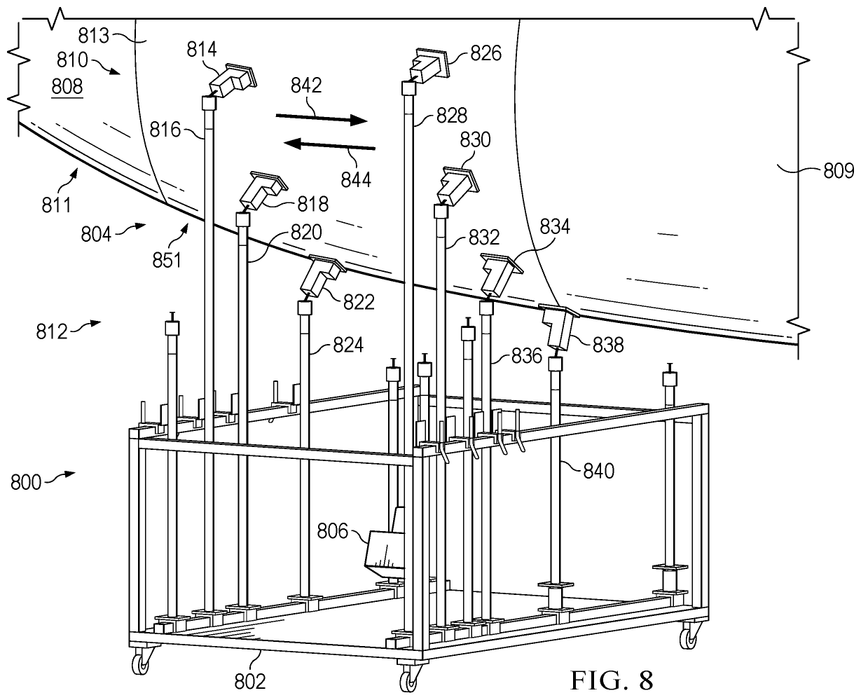

With reference now to FIG. 8, an illustration of a surface inspection system is depicted in accordance with an illustrative embodiment. Surface inspection system 800 is an example of one implementation of surface inspection system 102 shown in block form in FIG. 1. As depicted, surface inspection system 800 comprises platform 802, strobe lights 804, and camera 806.

As depicted, strobe lights 804 are positioned on platform 802 relative to surface 808 of aircraft fuselage 810. The positioning strobe lights 804 occurs using arms 812 on which strobe lights 804 are attached to arms 812. In this illustrative example, a first set of strobe lights comprises strobe light 814 is mounted on arm 816, strobe light 818 is mounted on arm 820, strobe light 822 is mounted on arm 824. A second set of strobe lights comprises strobe light 826 is mounted on arm 828, strobe light 830 is mounted on arm 832, strobe light 834 is mounted on arm 836, and strobe light 838 is mounted on arm 840.

The first set of strobe lights comprises strobe light 814, strobe light 818, and strobe light 822. This first set of strobe lights is aligned in direction 842. The second set of strobe lights comprises strobe light 826, strobe light 830, strobe light 834, and strobe light 838. The second set of strobe lights is aligned in direction 844. As depicted, direction 844 is an opposite direction to direction 842.

In this illustrative example, the first set of strobe lights emits flashes in direction 842. The flashes are synchronized flashes in which camera 806 captures an image while the flashes illuminate surface 808 for skin 809 of aircraft fuselage 810. After the emission of the flashes by the first set of strobe lights, the second set of strobe lights emits flashes that are synchronized with the image captured by camera 806. In other words, camera 806 captures an image while surface 808 for skin 809 of aircraft fuselage 810 is illuminated by flashes from the second set strobe lights.

In this example, camera 806 captures image of area 851.

In this illustrative example, aircraft fuselage 810 has frames 811. In this example, surface inspection system 800 is positioned to inspect frame 813 in frames 811. Surface inspection system 800 can be moved to inspect successive areas between frames 811.

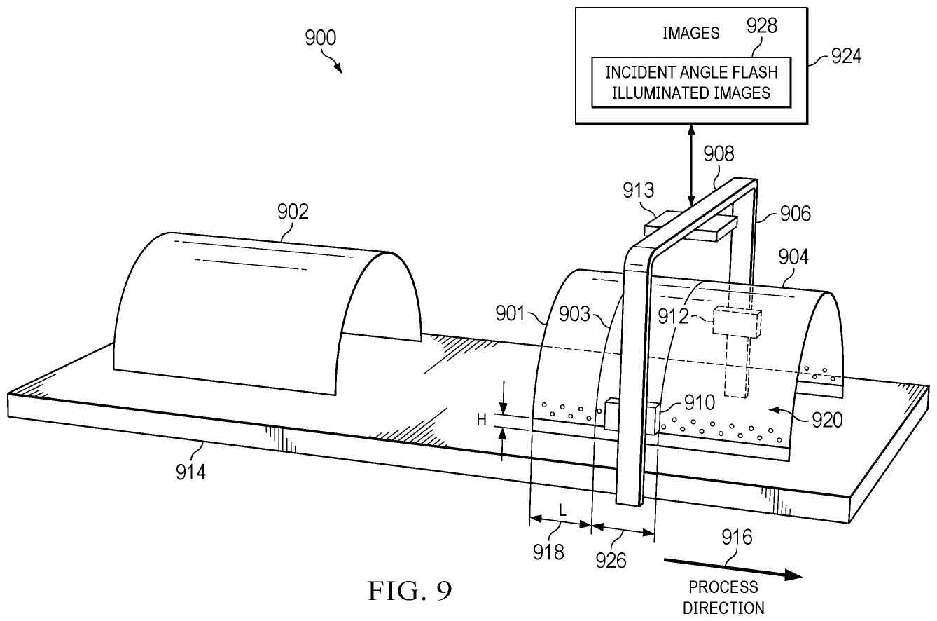

Turning now to FIG. 9, an illustration of a surface inspection station for inspecting fuselage sections in an assembly line process is depicted in accordance with an illustrative embodiment. As depicted, nondestructive inspection workstation 900 is a workstation in which visual inspections can be made of half barrel fuselage sections such as upper half barrel 902 and lower half barrel 904. In this illustrative example, surface inspection system 906 is an example of one implementation for surface inspection system 102 to FIG. 1. This example, surface inspection system 906 comprises frame 908, strobe light and camera module 910, strobe light and camera module 912, and strobe light and camera module 913. These strobe light and camera modules are examples of an implementation for strobe light system 110 and image capture system 112 in FIG. 1.

In this illustrative example, upper half barrel 902 and lower half barrel 904 move on track 914 in process direction 916. In this illustrative example, the movement is a pulsed movement but in other examples movement can be continuous movement.

With a pulsed movement, track 914 advances upper half barrel 902 and lower half barrel 904 by frame pitch 918 for each pulse. In this illustrative example, frame pitch 918 has a length L that is the distance between two successive frames in upper half barrel 902 and lower half barrel 904. For example, frame pitch 918 is the length L that is the distance from a centerline of frame 901 to a center line of next frame 903.

In this illustrative example, surface inspection system 906 can capture images 924 of surface 920 of lower half barrel 904 at each pulse. In this example, images 924 captured for next frame pitch 926. In this depicted example, images 924 encompass at least one frame pitch. After the capture of images 924 for frame pitch 918, upper half barrel 902 and lower half barrel 904 are pulsed such that next frame pitch 926 for lower half barrel 904 is positioned for image capture by surface inspection system 906 as shown in this figure.

In one illustrative example, images 924 can be incident angle flash illuminated images 928. In other illustrative examples, images 924 can be captured without a particular angle of incidence selected based on inconsistencies to be detected.

In other illustrative examples, surface inspection system 906 can be pulsed to move surface inspection system 906 from frame pitch 918 to next frame pitch 926.

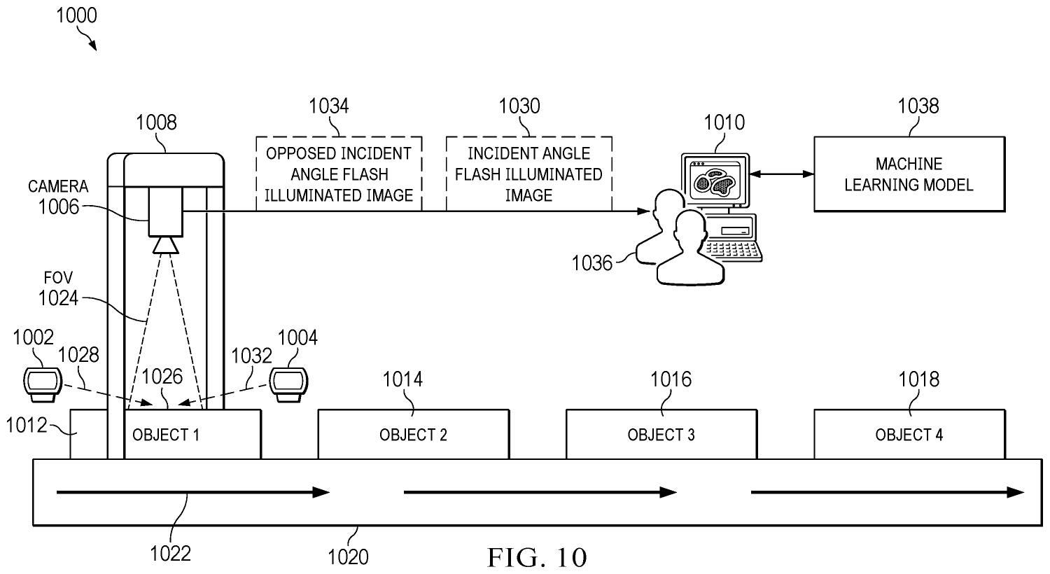

Turning now to FIG. 10, an illustration of a surface inspection system for inspecting objects is depicted in accordance with an illustrative embodiment. In this illustrative example, surface inspection system 1000 is an example of an implementation for surface inspection system 102 in FIG. 1.

As depicted, surface inspection system 1000 comprises strobe light 1002, strobe light 1004, camera 1006, frame 1008, and computer 1010. As depicted, objects such as object 1 1012, object 2 1014, object 3 1016, and object 4 1018 move on track 1020 in process direction 1022. With this example, inspection of these objects can be performed in an automated manner under the control of computer 1010.

In this illustrative example, movement of these objects can be in a pulsed manner to move in process direction 1022 to enable capturing images of surface 1026 of object 1 1012. For example, if camera 1006 has field-of-view (FOV) 1024 that is 10 inches, each pulse of track 1020 moves object 1 1012 10 inches relative to camera 1006. In other words, if surface inspection system 1000 is configured to capture or scan 10 inch increments, track 1020 is triggered to move objects 10 inches at each pulse. In this manner, all of surface 1026 for object 1 1012 can be captured for inspection.

After each pulse, strobe light 1002 emits synchronized flash 1028 at an incident angle. The emission of synchronized flash 1028 by strobe light 1002 is timed such that camera 1006 captures incident angle flash illuminated image 1030 during the time at which surface 1026 is illuminated by synchronized flash 1028.

Thereafter, strobe light 1004 emits synchronized flash 1032. Camera 1006 captures opposed incident angle flash illuminated image 1034 during the time surface 1026 is illuminated by synchronized flash 1032.

Incident angle flash illuminated image 1030 and opposed incident angle flash illuminated image 1034 are transmitted to computer 1010. Track 1020 is then pulsed to move object 1 1012 10 inches relative to surface inspection system 1000 and image capture process is repeated.

In this illustrative example, images can be transmitted at any time to computer 1010. For example, images can be transmitted as they are captured or after the images are captured for each object. In this illustrative example, computer 1010 inspects the images after all the images have been captured. This inspection can also be performed for each object as the images are captured or for some number of objects.

In one illustrative example, human operators 1036 can manually inspect images. In another illustrative example, the inspection can be performed automatically by a software process such as machine learning model 1038 in computer 1010.

Although the objects are shown moving relative to surface inspection system 1000 in this example, surface inspection system 1000 can move relative to the objects to capture images in other implementations. For example, frame 1008 can move along track 1020 in a pulsed fashion to capture images as described above.

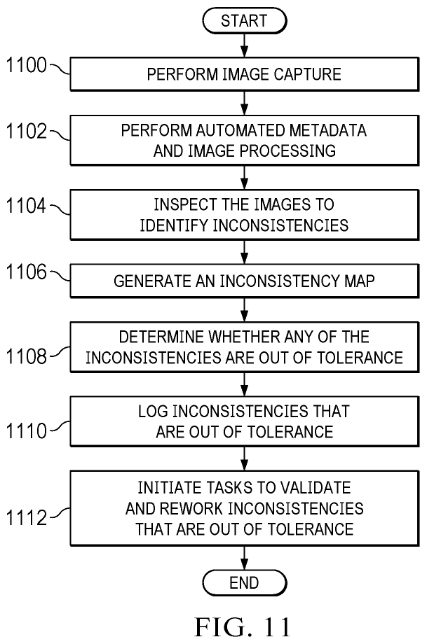

With reference now to FIG. 11, an illustration of a flowchart of a process for inspecting the surface of an object is depicted in accordance with an illustrative embodiment. The process in FIG. 11 can be performed using surface inspection system 1000 to FIG. 10.

As depicted, the process begins by performing image capture (operation 1100). In this illustrative example, image capture is performed using synchronized flashes to generate incident angle flash illuminated images of the surface of an object.

The process performs automated metadata and image processing (operation 1102). In this operation, metadata can be associated with the image such as an object identifier, camera settings, strobe light settings, location and other information. Further, each image can be associated with an area on the surface of the object. Image processing can also be performed. For example, processing can be performed to remove noise. As another example, processing of images can be performed such as combining images of an area to form an inspectable image of the area.

The process then inspects the images to identify inconsistencies (operation 1104). This inspection can be performed manually or through the use of software such as a machine learning model or other artificial intelligence system. Then generates an inconsistency map (operation 1106). This map identifies locations of inconsistencies on the object.

The process determines whether any of the inconsistencies are out of tolerance (operation 1108). This determination can be made using a specification identifying tolerances for the object. The process logs inconsistencies that are out of tolerance (1110). The process initiates tasks to validate and rework inconsistencies that are out of tolerance (operation 1112). In other words, an additional inspection can be initiated of a location where an inconsistency is out of tolerance. Rework can then be performed upon validating that inconsistency is out of tolerance. The process terminates thereafter.

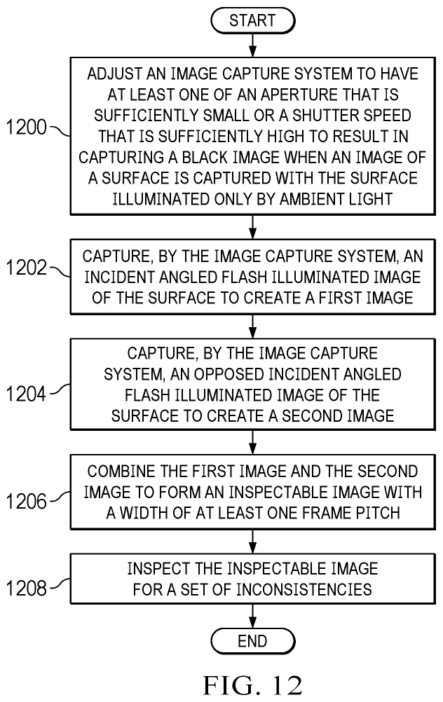

With reference to FIG. 12, an illustration of a flowchart of a process for inspecting a surface is depicted in accordance with an illustrative embodiment. The process illustrated in FIG. 12 can be implemented using surface inspection system 102 in FIG. 1. For example, the process can be implemented in controller 114 in surface inspection system 102 in FIG. 1.

The process begins by adjusting an image capture system to have at least one of an aperture that is sufficiently small or a shutter speed that is sufficiently high to result in capturing a black image when an image of a surface is captured with the surface illuminated only by ambient light (operation 1200). In operation 1200, the aperture can be set to from about f/8 to about f/22 and the shutter speed to about 1/75 of a second to about 1/1000 of the second. In this example, the shutter speed is said to be too fast to capture ambient light illuminated surfaces. Thus, shutter speed is sufficient to capture light in reflections from the set of flashes emitted at the area at the set of angles of incidence but the shutter speed is too fast to capture ambient light illuminated surfaces. In a similar fashion, the aperture is sufficient to capture lights and reflections from the set of flashes emitted at the area at the set of angles of incidence but is too small to capture ambient light illuminated surfaces.

The process captures, by the image capture system, an incident angled flash illuminated image of the surface to create a first image (operation 1202). The process captures, by the image capture system, an opposed incident angled flash illuminated image of the surface to create a second image (operation 1204).

The process combines the first image and the second image to form an inspectable image with a width of at least one frame pitch (operation 1206). The process inspects the inspectable image for a set of inconsistencies (operation 1208). The process terminates thereafter.

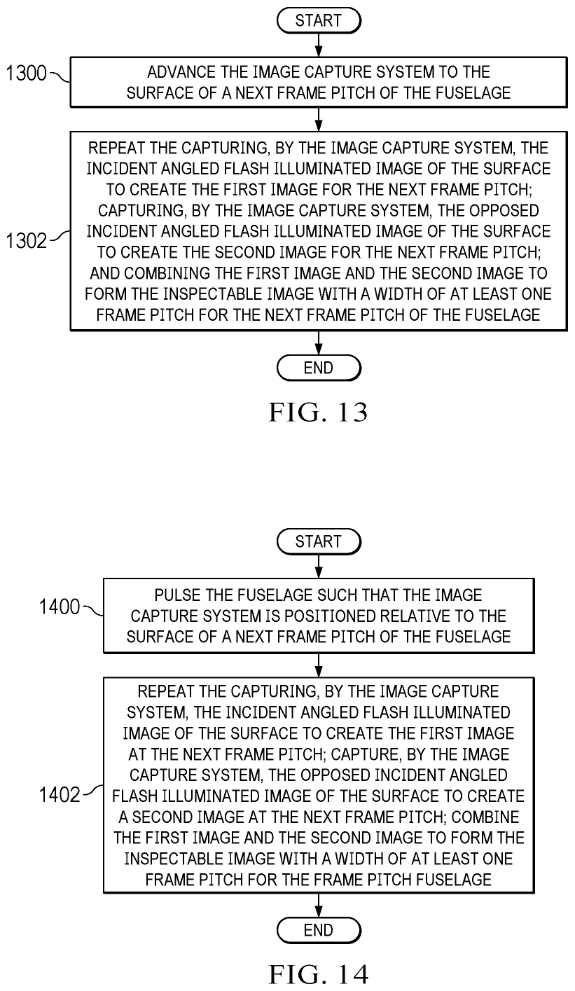

With reference now to FIG. 13, an illustration of a flowchart of a process for inspecting a surface for a fuselage of an aircraft is depicted in accordance with an illustrative embodiment. The operations in this figure are examples of additional operations that can be used within the operations in the process in FIG. 12.

The process advances the image capture system to the surface of a next frame pitch of the fuselage (operation 1300). The process repeats the capturing, by the image capture system, the incident angled flash illuminated image of the surface to create the first image for the next frame pitch; capturing, by the image capture system, the opposed incident angled flash illuminated image of the surface to create the second image for the next frame pitch; and combining the first image and the second image to form the inspectable image with a width of at least one frame pitch for the next frame pitch of the fuselage (operation 1302). The process terminates thereafter.

With reference now to FIG. 14, an illustration of a flowchart of a process for inspecting a surface for a fuselage of an aircraft is depicted in accordance with an illustrative embodiment. The operations in this figure are examples of additional operations that can be used within the operations in the process in FIG. 12.

The process pulses the fuselage such that the image capture system is positioned relative to the surface of a next frame pitch of the fuselage (operation 1400). The process repeats the capturing, by the image capture system, the incident angled flash illuminated image of the surface to create the first image at the next frame pitch; captures, by the image capture system, the opposed incident angled flash illuminated image of the surface to create a second image at the next frame pitch; and combines the first image and the second image to form the inspectable image with a width of at least one frame pitch for the frame pitch fuselage (operation 1402). The process terminates thereafter.

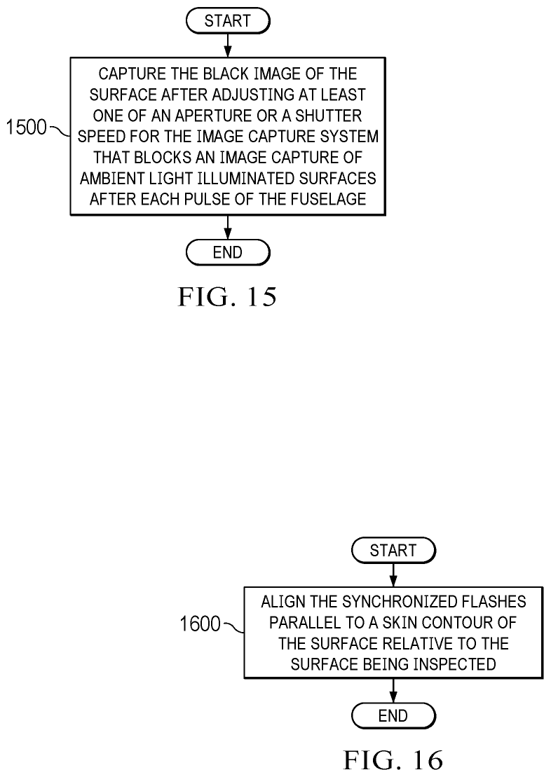

Turning next to FIG. 15, an illustration of a flowchart of a process for capturing a black image of the surface is depicted in accordance with an illustrative embodiment. The operations in this figure are examples of additional operations that can be used within the operations in the process in FIG. 14.

The process captures the black image of the surface after adjusting at least one of an aperture or a shutter speed for the image capture system that blocks an image capture of ambient light illuminated surfaces after each pulse of the fuselage (operation 1500). The process terminates thereafter. The black image verifies a set of camera settings are such that the ambient light illuminated surfaces are blocked from capture by the image capture system.

When black images are captured, at least one of the aperture is too small, the shutter speed is too fast, or the ISO is too low to facilitate capturing an ambient light illuminated image. In this illustrative example, operation 1500 can be performed as a calibration step to confirm an absence of ambient light contamination. This capturing of black images is performed without needing flashes from the strobe lights.

For example, the shutter speed is sufficient to capture light in reflections from the set of flashes emitted at the area at the set of angles of incidence. Shutter speed, however, is too fast to capture ambient light illuminated surfaces. As another example, the aperture can be sufficient to capture lighting reflections from the set of flashes emitted from the area at the set of angles of incidence. The aperture, however, is too small to capture ambient light illuminated surfaces.

In this illustrative example, shutter speed can be a main control for avoiding the capturing of ambient light while the aperture can be a secondary control. As another example, an ISO setting can be another secondary control for avoiding the capture of ambient light by sensors in the camera.

Turning next to FIG. 16, an illustration of a flowchart of a process for aligning synchronized flashes is depicted in accordance with an illustrative embodiment. The operations in this figure are examples of additional operations that can be used within the operations in the process in FIG. 14.

The process aligns the synchronized flashes parallel to a skin contour of the surface relative to the surface being inspected (operation 1600). The process terminates thereafter.

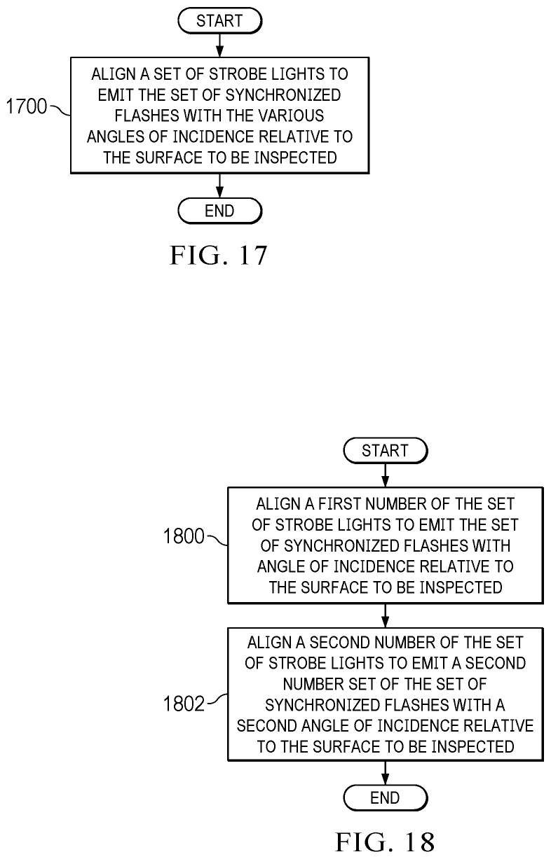

Turning next to FIG. 17, an illustration of a flowchart of a process for aligning a set of strobe lights is depicted in accordance with an illustrative embodiment. The operations in this figure are examples of additional operations that can be used within the operations in the process in FIG. 12.

The process aligns a set of strobe lights to emit the set of synchronized flashes with the various angles of incidence relative to the surface to be inspected (operation 1700). The process terminates thereafter.

Turning next to FIG. 18, an illustration of a flowchart of a process for aligning sets of strobe lights is depicted in accordance with an illustrative embodiment. The process illustrated in FIG. 18 is an example of one implementation for operation 1700 in FIG. 17.

The process aligns a first number of the set of strobe lights to emit the set of synchronized flashes with angle of incidence relative to the surface to be inspected (operation 1800). The process aligns a second number of the set of strobe lights to emit a second number of the set of synchronized flashes with a second angle of incidence relative to the surface to be inspected (operation 1802).

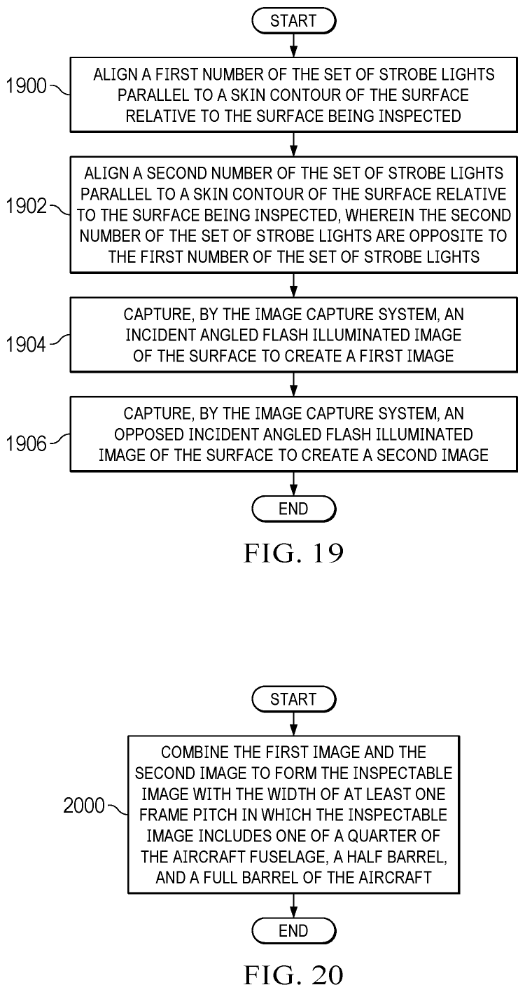

Turning next to FIG. 19, an illustration of a flowchart of a process for inspecting a surface is depicted in accordance with an illustrative embodiment. The operations in this figure are examples of additional operations that can be used within the operations in the process in FIG. 12.

The process aligns a first number of the set of strobe lights parallel to a skin contour of the surface relative to the surface being inspected (operation 1900). The process aligns a second number of the set of strobe lights parallel to a skin contour of the surface relative to the surface being inspected, wherein the second number of the set of strobe lights are opposite to the first number of the set of strobe lights (operation 1902).

The process captures, by the image capture system, an incident angled flash illuminated image of the surface to create a first image (operation 1904). The process captures, by the image capture system, an opposed incident angled flash illuminated image of the surface to create a second image (operation 1906). The process terminates thereafter.

Turning next to FIG. 20, an illustration of a flowchart of a process for combining images is depicted in accordance with an illustrative embodiment. The process illustrated in FIG. 20 is an example of one implementation for operation 1206 in FIG. 12. The process combines the first image and the second image to form the inspectable image with the width of at least one frame pitch in which the inspectable image in which the inspectable image includes one of a quarter (163) of the aircraft fuselage, a half barrel, and a full barrel (169) of the aircraft fuselage (810) (operation 2000). The process terminates thereafter. The combination of images can be helpful for increasing the ability to detect inconsistencies. However, this step is not required. The images captured without combining them can be inspected to detect inconsistencies.

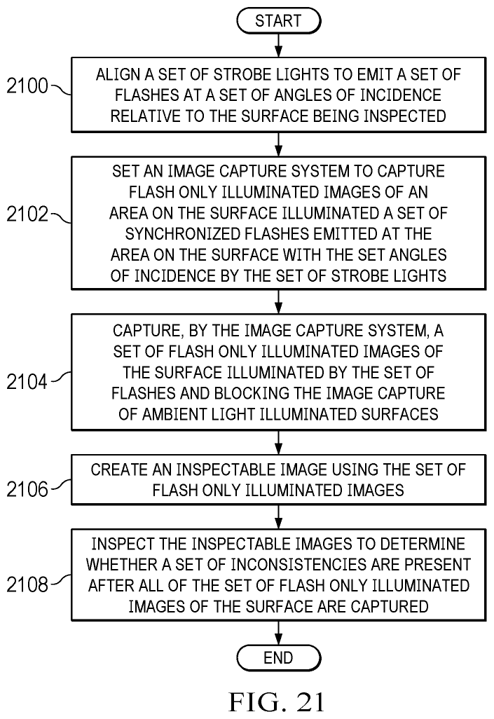

With reference to FIG. 21, an illustration of a flowchart of a process for inspecting a surface of an object is depicted in accordance with an illustrative embodiment. The process illustrated in FIG. 21 can be implemented using surface inspection system 102 in FIG. 1. For example, the process can be implemented in controller 114 in surface inspection system 102 in FIG. 1.

The process begins by aligning a set of strobe lights to emit a set of flashes at a set of angles of incidence relative to the surface to be inspected (operation 2100). The process sets an image capture system to capture flash only illuminated images of an area on the surface illuminated by a set of synchronized flashes emitted at the area on the surface with the set angles of incidence by the set of strobe lights (operation 2102).

The process captures, by the image capture system, a set of flash only illuminated images of the surface illuminated by the set of flashes and blocking the image capture of ambient light illuminated surfaces (operation 2104). The process creates an inspectable image using the set of flash only illuminated images (operation 2106). The process inspects the inspectable images to determine whether a set of inconsistencies are present after all of the set of flash only illuminated images of the surface are captured (operation 2108). The process terminates thereafter.

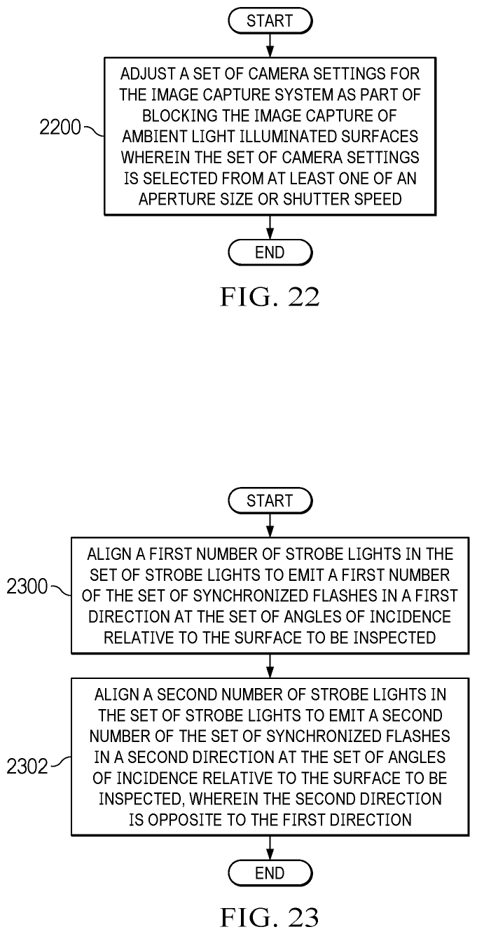

Turning next to FIG. 22, an illustration of a flowchart of a process for adjusting a set of camera settings is depicted in accordance with an illustrative embodiment. The operations in this figure are examples of additional operations that can be used within the operations in the process in FIG. 21.

The process adjusts a set of camera settings for the image capture system as part of blocking the image capture of ambient light illuminated surfaces wherein the set of camera settings is selected from at least one of an aperture or shutter speed (operation 2200). The process terminates thereafter. In operation 2200, the shutter speed is such that the shutter is open for a time sufficient to capture light from the set of flashes emitted at the area at the set of angles of incidence but insufficient for the image capture of ambient light illuminated surfaces

Turning next to FIG. 23, an illustration of a flowchart of a process for aligning strobe lights is depicted in accordance with an illustrative embodiment. The process illustrated in FIG. 23 is an example of one implementation for operation 2100 in FIG. 21.

The process aligns a first number of strobe lights in the set of strobe lights to emit a first number of the set of synchronized flashes in a first direction at the set of angles of incidence relative to the surface to be inspected (operation 2300). The process aligns a second number of strobe lights in the set of strobe lights to emit a second number of the set of synchronized flashes in a second direction at the set of angles of incidence relative to the surface to be inspected, wherein the second direction is opposite to the first direction (operation 2302). The process terminates thereafter.

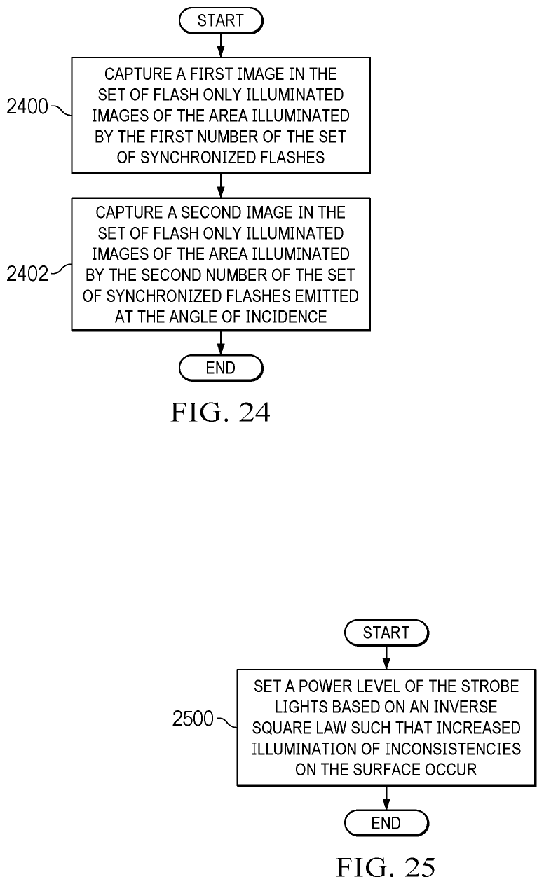

Turning next to FIG. 24, an illustration of a flowchart of a process for capturing images is depicted in accordance with an illustrative embodiment. The process illustrated in FIG. 23 is an example of one implementation for operation 2106 in FIG. 21.

The process captures a first image in the set of flash only illuminated images of the area illuminated by the first number of the set of synchronized flashes (operation 2400). The process captures a second image in the set of flash only illuminated images of the area illuminated by the second number of the set of synchronized flashes emitted at the angle of incidence (operation 2402). The process terminates thereafter.

Turning next to FIG. 25, an illustration of a flowchart of a process for setting a power level of strobe lights is depicted in accordance with an illustrative embodiment. The operations in this figure are examples of additional operations that can be used with in the operations in the process in FIG. 21.

The process sets a power level of the strobe lights based on an inverse square law such that increased illumination of inconsistencies on the surface occur (operation 2500). The process terminates thereafter. The power level can be set to 160 watt second resulting in an illumination distance of 16.5 feet with an inspection distance from about 4 feet to 12 feet

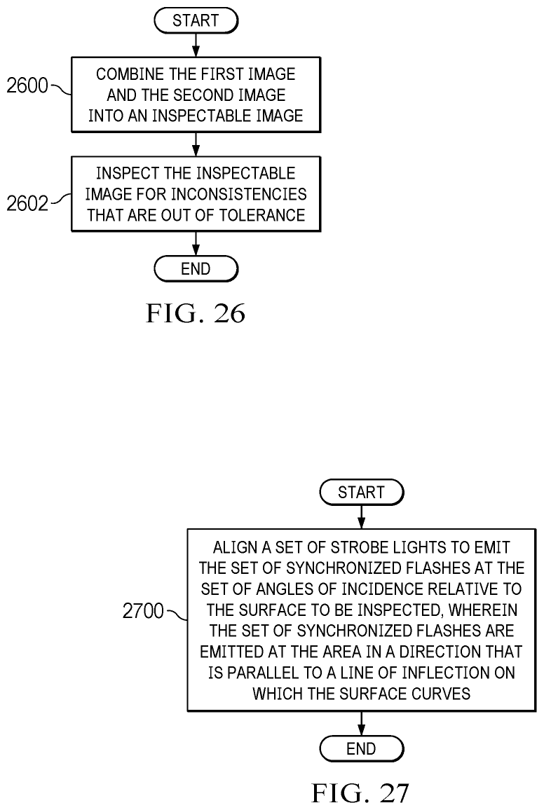

Turning next to FIG. 26, an illustration of a flowchart of a process for combining images is depicted in accordance with an illustrative embodiment. The operations in this figure are examples of additional operations that can be used within the operations in the process in FIG. 24.

The process combines the first image and the second image into an inspectable image (operation 2600). The process inspects the inspectable image for inconsistencies that are out of tolerance (operation 2602). The process terminates thereafter.

With reference to FIG. 27, an illustration of a flowchart of a process for aligning a set of strobe lights is depicted in accordance with an illustrative embodiment. The process in FIG. 27 is an example of one implementation for operation 2100 in FIG. 21.

The process aligns a set of strobe lights to emit the set of synchronized flashes at the set of angles of incidence relative to the surface to be inspected, wherein the set of synchronized flashes are emitted at the area in a direction that is parallel to a line of inflection on which the surface curves (operation 2700). The process terminates thereafter. In this flowchart, the surface can be at least a portion of a cylindrical shape.

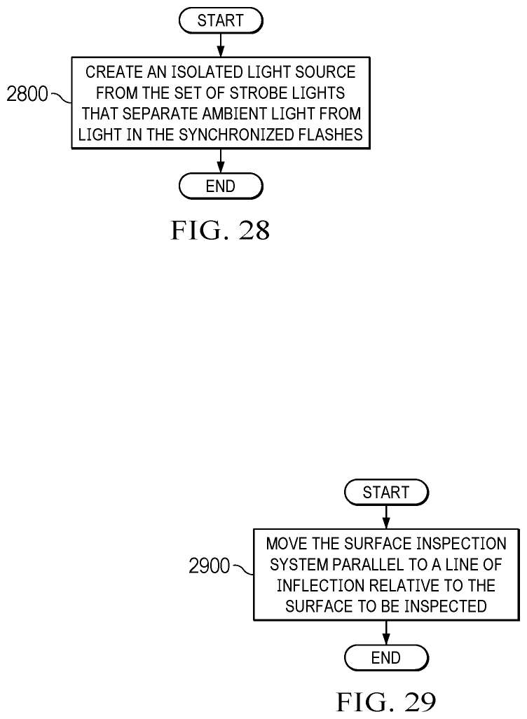

Turning next to FIG. 28, an illustration of a flowchart of a process for creating an isolated light source is depicted in accordance with an illustrative embodiment. The operations in this figure are examples of additional operations that can be used within the operations in the process in FIG. 21.

The process creates an isolated light source from the set of strobe lights that separate ambient light from light in the synchronized flashes (operation 2800). The process terminates thereafter.

Turning next to FIG. 29, an illustration of a flowchart of a process for moving the surface inspection system is depicted in accordance with an illustrative embodiment. The operations in this figure are examples of additional operations that can be used within the operations in the process in FIG. 21.

The process moves the surface inspection system parallel to a line of inflection relative to the surface to be inspected (operation 2900). The operation terminates thereafter.

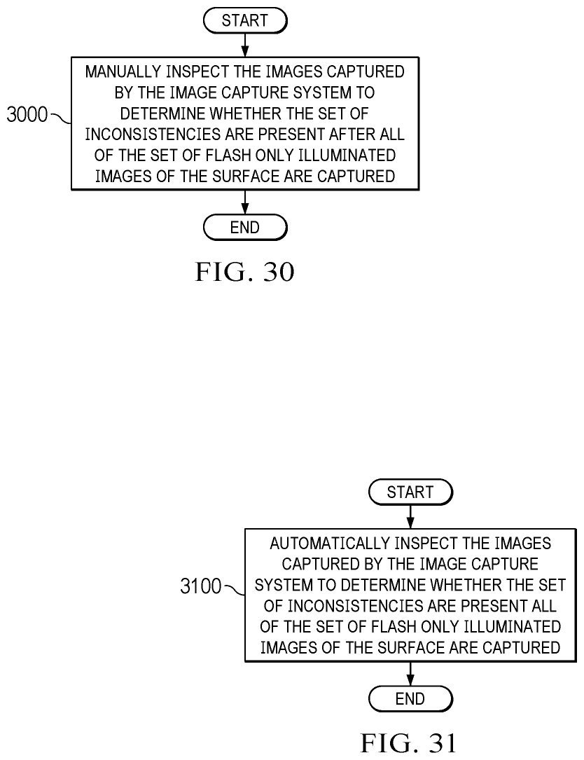

Turning next to FIG. 30, an illustration of a flowchart of a process for manually inspecting images is depicted in accordance with an illustrative embodiment. The process illustrated in FIG. 30 is an example of one implementation for operation 2108 in FIG. 21.

The process manually inspects the images captured by the image capture system to determine whether the set of inconsistencies are present after all of the set of flash only illuminated images of the surface are captured (operation 3000). The process terminates thereafter.

In FIG. 31, an illustration of a flowchart of a process for automatically inspecting images is depicted in accordance with an illustrative embodiment. The process illustrated in FIG. 30 is an example of one implementation for operation 2108 in FIG. 21.

The process automatically inspects the images captured by the image capture system to determine whether the set of inconsistencies are present after all of the set of flash only illuminated images of the surface are captured (operation 3100). The process terminates thereafter. The automatic inspection of images can be performed in a number of different ways. For example, in artificial intelligence system, knowledge base, machine learning model, or other suitable software can be used to inspect the images.

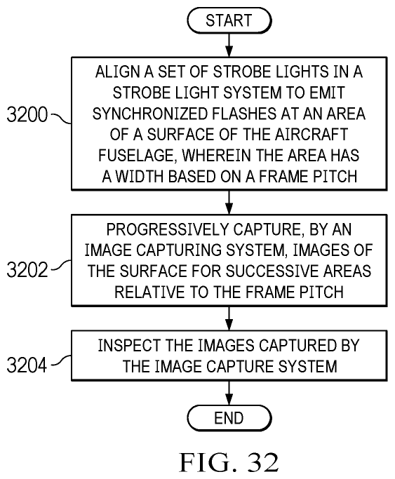

With reference to FIG. 32, an illustration of a flowchart of a process for inspecting a surface of an aircraft fuselage is depicted in accordance with an illustrative embodiment. The process illustrated in FIG. 32 can be implemented using surface inspection system 102 in FIG. 1. For example, the process can be implemented in controller 114 in surface inspection system 102 in FIG. 1.

The process begins by aligning a set of strobe lights in a strobe light system to emit synchronized flashes at an area of a surface of the aircraft fuselage, wherein the area has a width based on a frame pitch (operation 3200). The width can be selected from one of a multiple and a fraction of the frame pitch. In operation 3200, the area can have a height that is selected from one of a quarter of the aircraft fuselage and a half of the aircraft fuselage.

The process progressively captures, by an image capture system, images of the surface for successive areas relative to the frame pitch (operation 3202). The process inspects the images captured by the image capture system (operation 3204). The process terminates thereafter. In operation 3204 this inspection can be performed to determine whether a set of inconsistencies are present within the images.

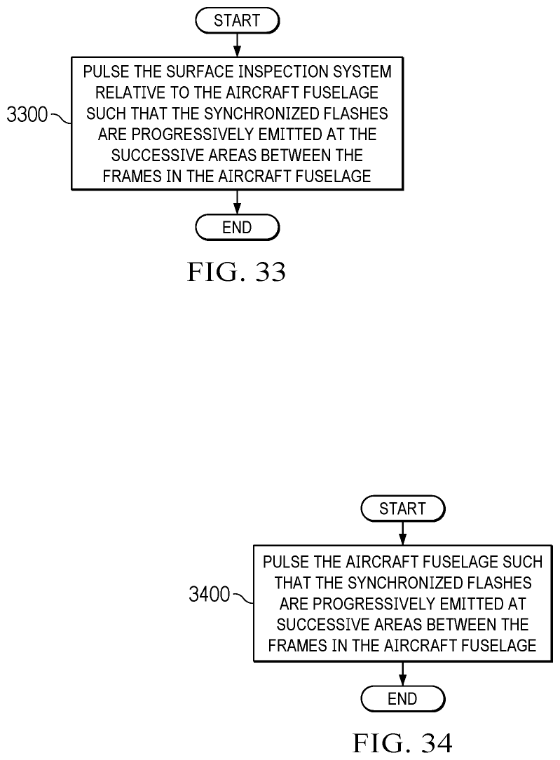

Turning next to FIG. 33, an illustration of a flowchart of a process for moving a surface inspection system in accordance with an illustrative embodiment. The operations in this figure are examples of additional operations that can be used with in the operations in the process in FIG. 32.

The process pulses the surface inspection system relative to the aircraft fuselage such that the synchronized flashes are progressively emitted at successive areas between the frames in the aircraft fuselage (operation 3300). The process terminates thereafter.

Turning next to FIG. 34, an illustration of a flowchart of a process for moving an aircraft fuselage in accordance with an illustrative embodiment. The operations in this figure are examples of additional operations that can be used within the operations in the process in FIG. 32.

The process pulses the aircraft fuselage such that the synchronized flashes are progressively emitted at successive areas between the frames in the aircraft fuselage (operation 3400). The process terminates thereafter.

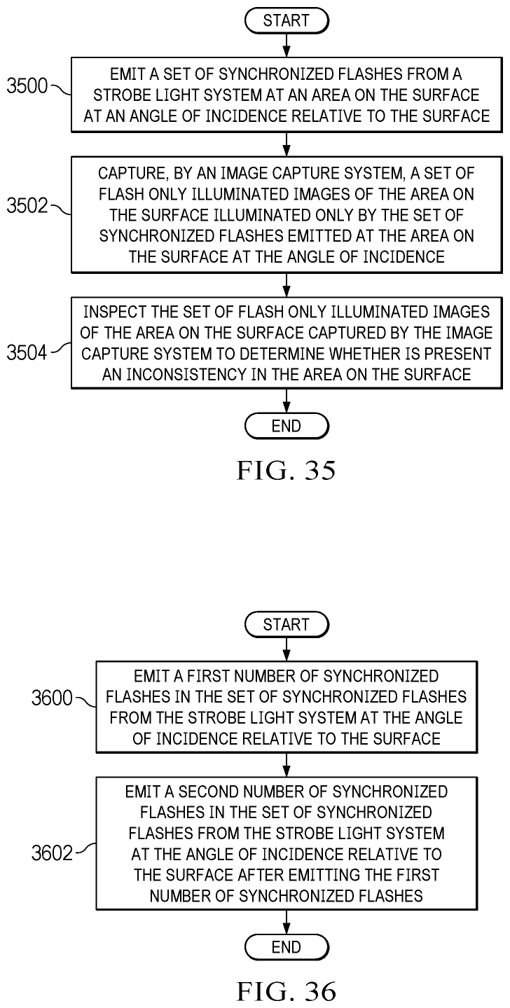

With reference to FIG. 35, an illustration of a flowchart of a process for inspecting a surface of an object is depicted in accordance with an illustrative embodiment. The process illustrated in FIG. 35 can be implemented using surface inspection system 102 in FIG. 1. For example, the process can be implemented in controller 114 in surface inspection system 102 in FIG. 1 to control the surface inspection of an object.

The process begins by emitting a set of synchronized flashes from a strobe light system at an area on the surface at an angle of incidence relative to the surface (operation 3500). The process captures, by an image capture system, a set of flash only illuminated images of the area on the surface illuminated only by the set of synchronized flashes emitted at the area on the surface at the angle of incidence (operation 3502).

The process inspects the set of flash only illuminated images of the area on the surface captured by the image capture system to determine whether is present an inconsistency in the area on the surface (operation 3504). The process terminates thereafter.

Turning next to FIG. 36, an illustration of a flowchart of a process for emitting synchronized flashes from a strobe light system in accordance with an illustrative embodiment. The process illustrated in FIG. 36 is an example of one implementation for operation 3500 in FIG. 35.

The process emits a first number of the synchronized flashes in the set of synchronized flashes from the strobe light system at the angle of incidence relative to the surface (operation 3600). The process emits a second number of synchronized flashes in the set of synchronized flashes from the strobe light system at the angle of incidence relative to the surface after emitting the first number of synchronized flashes (operation 3602). The process terminates thereafter.

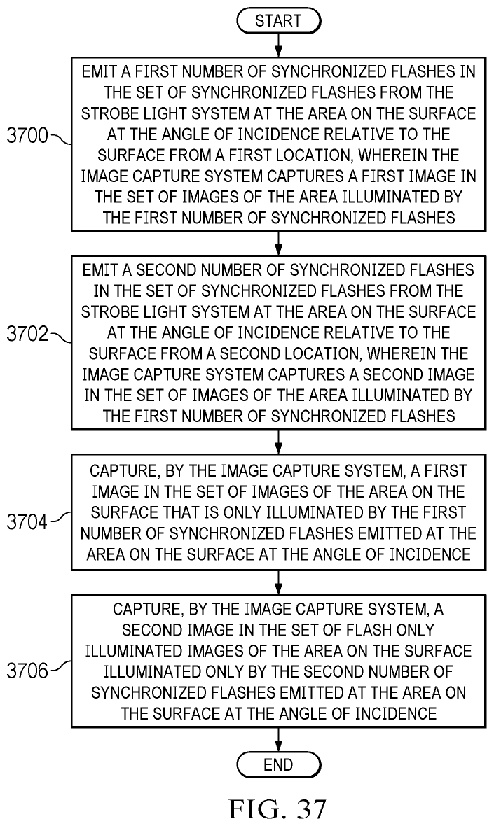

Turning next to FIG. 37, an illustration of a flowchart of a process for inspecting a surface of an object in accordance with an illustrative embodiment. The process illustrated in FIG. 37 is an example of one implementation for operations 3500 and 3502 in FIG. 35.

The process emits a first number of the synchronized flashes in the set of synchronized flashes from the strobe light system at the area on the surface at the angle of incidence relative to the surface from a first location, wherein the image capture system captures a first image in the set of images of the area illuminated by the first number of synchronized flashes (operation 3700). The process emits a second number of synchronized flashes in the set of synchronized flashes from the strobe light system at the area on the surface at the angle of incidence relative to the surface from a second location, wherein the image capture system captures a second image in the set of images of the area illuminated by the first number of synchronized flashes (operation 3702).

The process captures, by the image capture system, a first image in the set of images of the area on the surface that is only illuminated by the first number of synchronized flashes emitted at the area on the surface at the angle of incidence (operation 3704). The process captures, by the image capture system, a second image in the set of flash only illuminated images of the area on the surface illuminated only by the second number of synchronized flashes emitted at the area on the surface at the angle of incidence (operation 3706). The process terminates thereafter.

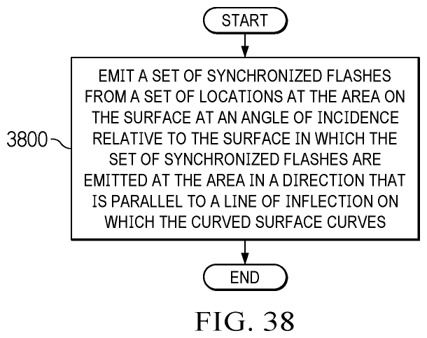

Turning next to FIG. 38, an illustration of a flowchart of a process for emitting synchronized flashes in accordance with an illustrative embodiment. The process illustrated in FIG. 38 is an example of one implementation for operation 3500 in FIG. 35.

The process emits the set of synchronized flashes from a set of locations at the area on the surface at an angle of incidence relative to the surface in which the set of synchronized flashes are emitted at the area in a direction that is parallel to a line of inflection on which the curved surface curves (operation 3800). The process terminates thereafter.

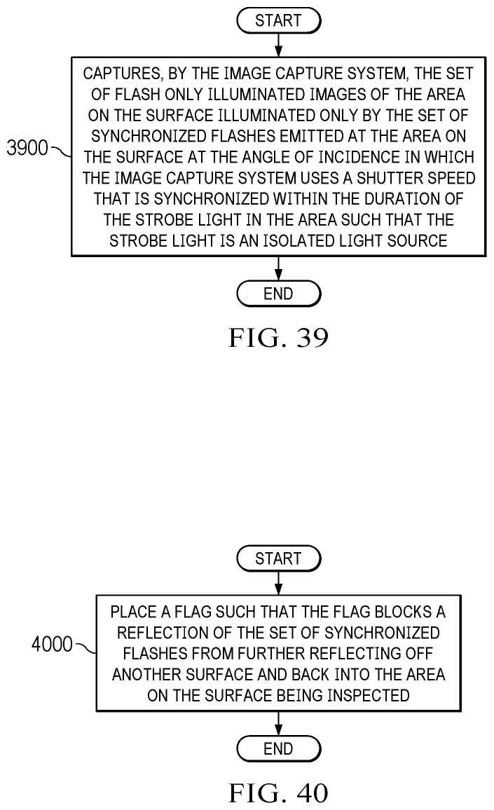

Turning next to FIG. 39, an illustration of a flowchart of a process for capturing flash only illuminated images in accordance with an illustrative embodiment. The process illustrated in FIG. 39 is an example of one implementation for operation 3502 in FIG. 35.

The process captures, by the image capture system, the set of flash only illuminated images of the area on the surface illuminated only by the set of synchronized flashes emitted at the area on the surface at the angle of incidence in which the image capture system uses a shutter speed that is synchronized within the duration of the strobe light in the area such that the strobe light is an isolated light source (operation 3900). The process terminates thereafter.

Turning next to FIG. 40, an illustration of a flowchart of a process for placing a flag in accordance with an illustrative embodiment. The operations in this figure are examples of additional operations that can be used within the operations in the process in FIG. 35.

The process places a flag such that the flag blocks a reflection of the set of synchronized flashes from further reflecting off another surface and back into the area on the surface being inspected (operation 4000). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

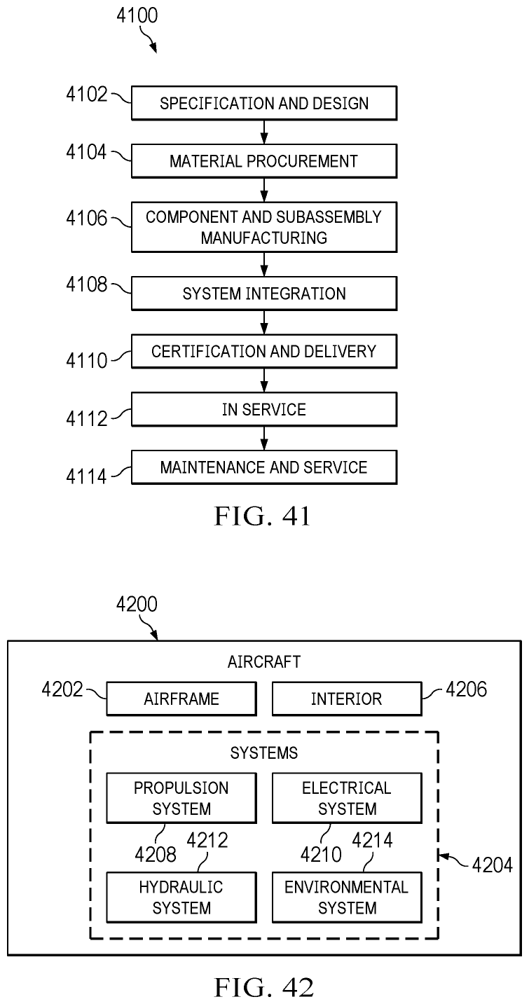

Illustrative embodiments of the disclosure may be described in the context of aircraft manufacturing and service method 4100 as shown in FIG. 41 and aircraft 4200 as shown in FIG. 42. Turning first to FIG. 41, an illustration of a block diagram of an aircraft manufacturing and service method is depicted in accordance with an illustrative embodiment. During pre-production, aircraft manufacturing and service method 4100 may include specification and design 4102 of aircraft 4200 in FIG. 42 and material procurement 4104.

During production, component and subassembly manufacturing 4106 and system integration 4108 of aircraft 4200 in FIG. 42 takes place. Thereafter, aircraft 4200 in FIG. 42 can go through certification and delivery 4110 in order to be placed in service 4112. While in service 4112 by a customer, aircraft 4200 in FIG. 42 is scheduled for routine maintenance and service 4114, which may include modification, reconfiguration, refurbishment, and other maintenance or service.

Each of the processes of aircraft manufacturing and service method 4100 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 42, an illustration of a block diagram of an aircraft is depicted in which an illustrative embodiment may be implemented. In this example, aircraft 4200 is produced by aircraft manufacturing and service method 4100 in FIG. 41 and may include airframe 4202 with plurality of systems 4204 and interior 4206. Examples of systems 4204 include one or more of propulsion system 4208, electrical system 4210, hydraulic system 4212, and environmental system 4214. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 4100 in FIG. 41.

In one illustrative example, components or subassemblies produced in component and subassembly manufacturing 4106 in FIG. 41 can be fabricated or manufactured in a manner similar to components or subassemblies produced while aircraft 4200 is in service 4112 in FIG. 41. As yet another example, one or more apparatus embodiments, method embodiments, or a combination thereof can be utilized during production stages, such as component and subassembly manufacturing 4106 and system integration 4108 in FIG. 41. One or more apparatus embodiments, method embodiments, or a combination thereof may be utilized while aircraft 4200 is in service 4112, during maintenance and service 4114 in FIG. 41, or both. The use of a number of the different illustrative embodiments may substantially expedite the assembly of aircraft 4200, reduce the cost of aircraft 4200, or both expedite the assembly of aircraft 4200 and reduce the cost of aircraft 4200.

For example, with the use of a surface inspection system, such as surface inspection system 102 in FIG. 1, inconsistencies can be detected with more accuracy and address sooner during the manufacture of aircraft 4200. This type of detection can reduce the need to disassemble components for aircraft 4200 at a later time.

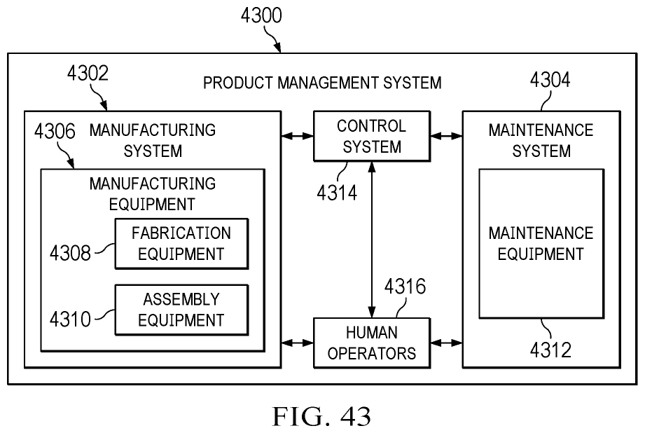

Turning now to FIG. 43, an illustration of a block diagram of a product management system is depicted in accordance with an illustrative embodiment. Product management system 4300 is a physical hardware system. In this illustrative example, product management system 4300 includes at least one of manufacturing system 4302 or maintenance system 4304.

Manufacturing system 4302 is configured to manufacture products, such as aircraft 4200 in FIG. 42. As depicted, manufacturing system 4302 includes manufacturing equipment 4306. Manufacturing equipment 4306 includes at least one of fabrication equipment 4308 or assembly equipment 4310.

Fabrication equipment 4308 is equipment that is used to fabricate components or parts used to form aircraft 4200 in FIG. 42. For example, fabrication equipment 4308 can include machines and tools. These machines and tools can be at least one of a drill, a hydraulic press, a furnace, an autoclave, a mold, a composite tape laying machine, an automated fibre placement (AFP) machine, a vacuum system, a robotic pick and place system, a flatbed cutting machine, a laser cutter, a computer numerical control (CNC) cutting machine, a lathe, or other suitable types of equipment. Fabrication equipment 4308 can be used to fabricate at least one of metal parts, composite parts, semiconductors, circuits, fasteners, ribs, skin panels, spars, antennas, or other suitable types of parts.

Assembly equipment 4310 is equipment used to assemble parts to form aircraft 4200 in FIG. 42. In particular, assembly equipment 4310 is used to assemble components and parts to form aircraft 4200 in FIG. 42. Assembly equipment 4310 also can include machines and tools. These machines and tools may be at least one of a robotic arm, a crawler, a fastener installation system, a rail-based drilling system, or a robot. Assembly equipment 4310 can be used to assemble parts such as seats, horizontal stabilizers, wings, engines, engine housings, landing gear systems, and other parts for aircraft 4200 in FIG. 42.

In this illustrative example, maintenance system 4304 includes maintenance equipment 4312. Maintenance equipment 4312 can include any equipment needed to perform maintenance on aircraft 4200 in FIG. 42. Maintenance equipment 4312 may include tools for performing different operations on parts on aircraft 4200 in FIG. 42. These operations can include at least one of disassembling parts, refurbishing parts, inspecting parts, reworking parts, manufacturing replacement parts, or other operations for performing maintenance on aircraft 4200 in FIG. 42. These operations can be for routine maintenance, inspections, upgrades, refurbishment, or other types of maintenance operations.

In the illustrative example, maintenance equipment 4312 may include ultrasonic inspection devices, x-ray imaging systems, vision systems, drills, crawlers, and other suitable devices. In some cases, maintenance equipment 4312 can include fabrication equipment 4308, assembly equipment 4310, or both to produce and assemble parts that needed for maintenance.

Product management system 4300 also includes control system 4314. Control system 4314 is a hardware system and may also include software or other types of components. Control system 4314 is configured to control the operation of at least one of manufacturing system 4302 or maintenance system 4304. In particular, control system 4314 can control the operation of at least one of fabrication equipment 4308, assembly equipment 4310, or maintenance equipment 4312.

The hardware in control system 4314 can be implemented using hardware that may include computers, circuits, networks, and other types of equipment. The control may take the form of direct control of manufacturing equipment 4306. For example, robots, computer-controlled machines, and other equipment can be controlled by control system 4314. In other illustrative examples, control system 4314 can manage operations performed by human operators 4316 in manufacturing or performing maintenance on aircraft 4200. For example, control system 4314 can assign tasks, provide instructions, display models, or perform other operations to manage operations performed by human operators 4316. In these illustrative examples, controller 114 in FIG. 1 can be implemented in control system 4314 to manage at least one of the manufacturing or maintenance of aircraft 4200 in FIG. 42. Controller 114 can control the operation of a surface inspection system to perform inspections during at least one of manufacturing or maintenance of aircraft 4200 in FIG. 42.

In the different illustrative examples, human operators 4316 can operate or interact with at least one of manufacturing equipment 4306, maintenance equipment 4312, or control system 4314. This interaction can occur to manufacture aircraft 4200 in FIG. 42.

Of course, product management system 4300 may be configured to manage other products other than aircraft 4200 in FIG. 42. Although product management system 4300 has been described with respect to manufacturing in the aerospace industry, product management system 4300 can be configured to manage products for other industries. For example, product management system 4300 can be configured to manufacture products for the automotive industry as well as any other suitable industries.

Some features of the illustrative examples are described in the following clauses. These clauses are examples of features and are not intended to limit other illustrative examples.

Some features of the illustrative examples are described in the following clauses. These clauses are examples of features not intended to limit other illustrative examples.

Clause 1

A method for inspecting a surface comprising:
adjusting at least one of an aperture or a shutter speed in an image capture system to result in capturing a black image when an image of a surface is captured with the surface illuminated only by an ambient light;
capturing, by the image capture system, an incident angled flash illuminated image of the surface to create a first image;
capturing, by the image capture system, an opposed incident angled flash illuminated image of the surface to create a second image;
combining the first image and the second image to form an inspectable image with a width of at least one frame pitch; and
inspecting the inspectable image.

Clause 2

The method according to clause 1, wherein adjusting at least one of the aperture or the shutter speed in the image capture system to result in capturing the black image when the image of the surface is captured with the surface illuminated only by the ambient light comprises:
adjusting an image capture system to have of the aperture that is a sufficiently small to result in capturing the black image when the image of the surface is captured with the surface illuminated only by the ambient light.

Clause 3

The method according to one of clauses 1 or 2, wherein adjusting at least one of the aperture or the shutter speed in the image capture system to result in capturing the black image when the image of the surface is captured with the surface illuminated only by the ambient light comprises:
adjusting an image capture system to have the shutter speed that is sufficiently high to result in capturing the black image when the image of the surface is captured with the surface illuminated only by an ambient light.

Clause 4

The method according to one of clauses 1, 2, or 3, wherein inspecting the inspectable image comprises:
inspecting the inspectable image for a set of inconsistencies.

Clause 5

The method according to one of clauses 1, 2, 3, or 4, wherein the surface is for a skin of an aircraft fuselage of an aircraft and further comprising:
advancing the image capture system to the surface of a next frame pitch of the aircraft fuselage; and
repeating the capturing, by the image capture system, the incident angled flash illuminated image of the surface to create the first image for the next frame pitch; capturing, by the image capture system, the opposed incident angled flash illuminated image of the surface to create the second image for the next frame pitch; and combining the first image and the second image to form the inspectable image with a width of at based on a frame pitch for the next frame pitch of the aircraft fuselage.

Clause 6

The method according to clause 5, wherein the width is selected from one of a multiple and a fraction of the frame pitch.

Clause 7

The method according to one of clauses 1, 2, 3, 4, 5, or 6, wherein the surface is for an aircraft fuselage of an aircraft and further comprising:
pulsing the aircraft fuselage such that the image capture system is positioned relative to the surface of a next frame pitch of the aircraft fuselage; and
repeating the capturing, by the image capture system, the incident angled flash illuminated image of the surface to create the first image at the next frame pitch; capturing, by the image capture system, the opposed incident angled flash illuminated image of the surface to create a second image at the next frame pitch; and combining the first image and the second image to form the inspectable image with a width of at least one frame pitch for the next frame pitch of the aircraft fuselage.

Clause 8

The method according to one of clauses 1, 2, 3, 4, 5, 6, or 7, wherein adjusting at least one of the aperture or the shutter speed in the image capture system to result in capturing the black image when the image of the surface is captured with the surface illuminated only by the ambient light comprises:
setting the aperture to from about f/8 to about f/22.

Clause 9

The method according to one of clauses 1, 2, 3, 4, 5, 6, 7, or 8, wherein adjusting at least one of the aperture or the shutter speed in the image capture system to result in capturing a black image when the image of the surface is captured with the surface illuminated only by the ambient light comprises:
setting the shutter speed to about 1/75 of a second to about 1/1000 of the second.

Clause 10

The method according to clause 7, further comprising:
capturing the black image of the surface after adjusting at least one of the aperture or the shutter speed for the image capture system that blocks an image capture of ambient light illuminated surfaces after each pulse of the aircraft fuselage.

Clause 11

The method according to one of clauses 1, 2, 3, 4, 5, 6, 7, 8, 9, or 10, wherein the surface is for an aircraft fuselage of an aircraft and further comprising:
pulsing the image capture system such that the image capture system is positioned relative to the surface of a next frame pitch of the aircraft fuselage;
repeating the capturing, by the image capture system, the incident angled flash illuminated image of the surface to create the first image at the next frame pitch; capturing, by the image capture system, the opposed incident angled flash illuminated image of the surface to create a second image at the next frame pitch; and combining the first image and the second image to form the inspectable image with a width of at least one frame pitch for the next frame pitch of the aircraft fuselage.

Clause 12

The method according to one of clauses 7, 8, 9, 10, 11, or 12, further comprising:
aligning synchronized flashes parallel to a skin contour) of the surface relative to the surface being inspected.

Clause 13

The method according to one of clauses 1, 2, 3, 4, 5, 6, 7, 8, 9, 10, 11, or 12 further comprising:
aligning a set of strobe lights to emit the set of synchronized flashes with various angles of incidence relative to the surface to be inspected.

Clause 14

The method according to clause 13, wherein aligning the set of strobe lights to emit the set of synchronized flashes with the various angles of incidence relative to the surface to be inspected comprises:
aligning a first number of the set of strobe lights to emit the set of synchronized flashes with an angle of incidence relative to the surface to be inspected; and
aligning a second number of the set of strobe lights to emit a second number of the set of synchronized flashes with a second angle of incidence relative to the surface to be inspected.

Clause 15

The method according to one of clauses 1, 2, 3, 4, 5, 6, 7, 8, 9, 10, 11, 12, 13, or 14 further comprising:
aligning a first number of a set of strobe lights parallel to a skin contour of the surface relative to the surface being inspected;
aligning a second number of the set of strobe lights parallel to a skin contour of the surface relative to the surface being inspected, wherein the second number of the set of strobe lights are opposite to the first number of the set of strobe lights;
capturing, by the image capture system, an incident angled flash illuminated image of the surface to create a first image; and
capturing, by the image capture system, an opposed incident angled flash illuminated image of the surface to create a second image.

Clause 16

The method according to one of clauses 1, 2, 3, 4, 5, 6, 7, 8, 9, 10, 11, 12, 13, 14, or 15, wherein combining the first image and the second image to form the inspectable image with the width of at least one frame pitch comprises:
combining the first image and the second image to form the inspectable image having a width of at least one frame pitch in which the inspectable image includes one of a quarter of the aircraft fuselage a half barrel, and a full barrel of an aircraft fuselage.

Clause 17

The method according to one of clauses 1, 2, 3, 4, 5, 6, 7, 8, 9, 10, 11, 12, 13, 14, 15, or 16, wherein capturing, by the image capture system, the incident angled flash illuminated image of the surface to create the first image and capturing, by the image capture system, the opposed incident angled flash illuminated image of the surface to create the second image comprises:
capturing, by the image capture system, the incident angled flash illuminated image of the surface to create the first image and capturing, by the image capture system, the opposed incident angled flash illuminated image of the surface to create the second image, wherein the first image and the second image each have a width that is one of a multiple of the frame pitch and a fraction of the frame pitch.

Clause 18

The method according to one of clauses 1, 2, 3, 4, 5, 6, 7, 8, 9, 10, 11, 12, 13, 14, 15, 16, or 17, wherein capturing, by the image capture system, the incident angled flash illuminated image of the surface to create the first image and capturing, by the image capture system, the opposed incident angled flash illuminated image of the surface to create the second image are part of capturing a set of incident angled flash illuminated images of the surface to create first images of a circumference of a barrel section for an aircraft fuselage and a set of opposed incident angled flash illuminated image of the surface to create second image of the circumference of a barrel section for the aircraft fuselage, wherein each first image and each second image is captured by a set of cameras in the image capture system.

Clause 19

The method according to clause 18, wherein combining the first image and the second image to form the inspectable image with the width of at least one frame pitch are part of combining the first image and the second image into the inspectable image of the barrel section for the aircraft fuselage.

Clause 20

A method for inspecting a surface of an object, the method comprising:
aligning a set of strobe lights to emit a set of flashes at a set of angles of incidence relative to the surface to be inspected;
setting an image capture system to capture flash only illuminated images of an area on the surface illuminated by a set of synchronized flashes emitted at the area on the surface with the set angles of incidence by the set of strobe lights;
capturing, by the image capture system, a set of flash only illuminated images of the surface illuminated by the set of flashes; and
creating an inspectable image using the set of flash only illuminated images.

Clause 21

The method according to clause 20, wherein capturing, by the image capture system, a set of flash only illuminated images of the surface illuminated by the set of flashes comprises:
capturing, by the image capture system, a set of flash only illuminated images of the surface illuminated by the set of flashes and blocking an image capture of an ambient light illuminated surfaces.

Clause 22

The method according to one of clauses 20 or 21 further comprising:
inspecting inspectable images to determine whether a set of inconsistencies are present after all of the set of flash only illuminated images of the surface are captured.

Clause 23

The method according to one of clauses 20, 21, or 22 further comprising:
capturing a black image after adjusting an aperture.

Clause 24

The method according to one of clauses 20, 21, 22, or 23 further comprising:
capturing a black image after adjusting a shutter speed of the image capture system.

Clause 25

The method according to one of clauses 20, 21, 22, 23, or 24 further comprising:
adjusting a set of camera settings for the image capture system as part of blocking the image capture of ambient light illuminated surfaces wherein the set of camera settings is selected from at least one of an aperture or shutter speed.

Clause 26

The method according to clause 24, wherein the shutter speed is sufficient to capture light in reflections from the set of flashes emitted at the area at the set of angles of incidence but the shutter speed is too fast to capture ambient light illuminated surfaces.

Clause 27

The method according to one of clauses 26 or 27, wherein an aperture is sufficient to capture light in reflections from the set of flashes emitted at the area at the set of angles of incidence but the aperture is too small to capture ambient light illuminated surfaces.

Clause 28

The method according to one of clauses 21, 22, 23, 24, 25, 26, or 27, wherein capturing, by the image capture system, the set of the flash only illuminated images of the area of the surface illuminated by the set of flashes and blocking the image capture of ambient light illuminated surfaces comprises:

capturing, by the image capture system, the set of the flash only illuminated images of the area of the surface illuminated by the set of flashes and not capturing the ambient light illuminated surfaces using a shutter speed from about 1/160 of a second to about 1/250 of a second.

Clause 29

The method according to one of clauses 20, 21, 22, 23, 24, 25, 26, 27, 28, or 29 further comprising:
capturing a black image without emitting the set of flashes, wherein the black image verifies a set of camera settings are such that ambient light illuminated surfaces are blocked from capture by the image capture system.

Clause 30

The method according to one of clauses 22, 23, 24, 25, 26, 27, 28, 29, or 30, wherein aligning the set of strobe lights to emit the set of flashes at the set of angles of incidence relative to the surface to be inspected comprises:
aligning a first number of strobe lights in the set of strobe lights to emit a first number of the set of synchronized flashes in a first direction at the set of angles of incidence relative to the surface to be inspected; and
aligning a second number of strobe lights in the set of strobe lights to emit a second number of the set of synchronized flashes in a second direction at the set of angles of incidence relative to the surface to be inspected, wherein the second direction is opposite to the first direction.

Clause 31

The method according to one of clauses 21, 22, 23, 24, 25, 26, 27, 28, 29, or 30, wherein capturing, by the image capture system, the set of flash only illuminated images of the surface illuminated by the set of synchronized flashes while blocking capture images of the surface illuminated by ambient light comprises:
capturing a first image in the set of flash only illuminated images of the area illuminated by a first number of the set of synchronized flashes; and
capturing a second image in the set of flash only illuminated images of the area illuminated by a second number of the set of synchronized flashes emitted at the angle of incidence.

Clause 32

The method according to one of clauses 21, 22, 23, 24, 25, 26, 27, 28, 29, 30, or 31, wherein capturing, by the image capture system, the set of the flash only illuminated images of the surface illuminated by the set of synchronized flashes while blocking capture images of surface illuminated by the ambient light comprises:
capturing a first image in the set of flash only illuminated images of the area illuminated by a first number of the set of synchronized flashes emitted at a first angle of incidence in the set of angles of incidence; and
capturing a second image in the set of flash only illuminated images of the area illuminated by a second number of the set of synchronized flashes emitted at a second angle of incidence in the set of angles of incidence.

Clause 33

The method according to one of clauses 20, 21, 22, 23, 24, 25, 26, 27, 28, 29, 30, 31, or 32 further comprising:
setting a power level of the strobe lights based on an inverse square law such that increased illumination of inconsistencies on the surface occur.

Clause 34

The method according to clause 33, wherein the level set to 160-watt second results in an illumination distance of 16.5 feet with an inspection distance from about 4 feet to 12 feet.

Clause 35

The method according to one of clauses 31, 32, 33, or 34 further comprising:
combining the first image and the second image into an inspectable image; and
inspecting the inspectable image for inconsistencies that are out of tolerance.

Clause 36

The method according to one of clauses 20, 21, 22, 23, 24, 25, 26, 27, 28, 29, 30, 31, 32, 33, 34, or 35, wherein the surface is contoured in one direction and wherein aligning the set of strobe lights to emit a set of flashes at a set of angles of incidence relative to the surface to be inspected comprises:
aligning a set of strobe lights to emit the set of synchronized flashes at the set of angles of incidence relative to the surface to be inspected, wherein the set of synchronized flashes are emitted at the area in a direction that is parallel to a line of inflection on which the surface curves.

Clause 37

The method according to clause 36, wherein the surface is at least a portion of a cylindrical shape.

Clause 38

The method according to one of clauses 36 or 37, wherein aligning a set of strobe lights to emit a set of synchronized flashes at the set of angles of incidence relative to the surface to be inspected comprises:
aligning the set of strobe lights to emit the set of synchronized flashes with various angles of incidence relative to the surface to be inspected.

Clause 39

The method according to clause 38, wherein aligning the set of strobe lights to emit the set of synchronized flashes with the various angles of incidence relative to the surface to be inspected comprises:
aligning a first number of the set of strobe lights to emit a first number of the set of synchronized flashes with a first angle of incidence relative to the surface to be inspected; and
aligning a second number of the set of strobe lights to emit a second number of the set of synchronized flashes with a second angle of incidence relative to the surface to be inspected.

Clause 40

The method according to one of clauses 38 or 39, wherein the various angles of incidence is selected from a group comprising 80 degrees for at least one of hair line cracks or dust and 60 degrees for a dent.

Clause 41

The method according to one of clauses 20, 21, 22, 23, 24, 25, 26, 27, 28, 29, 30, 31, 32, 33, 34, 35, 36, 37, 38, 39, or 40 further comprising:
creating an isolated light source from the set of strobe lights that separate an ambient light from a light in the synchronized flashes.

Clause 42

The method according to one of clauses 20, 21, 22, 23, 24, 25, 26, 27, 28, 29, 30, 31, 32, 33, 34, 35, 36, 37, 38, 39, 40, or 41, wherein the set of strobe lights and the image capture system form a surface inspection system and further comprising:
moving the surface inspection system parallel to a line of inflection relative to the surface to be inspected.

Clause 43

The method according to one of clauses 22, 23, 24, 25, 26, 27, 28, 29, 30, 31, 32, 33, 34, 35, 36, 37, 38, 39, 40, 41, or 42, wherein inspecting the inspectable images to determine whether the set of inconsistencies are present after all of the set of flash only illuminated images of the surface are captured comprises:
manually inspecting the inspectable images captured by the image capture system to determine whether the set of inconsistencies are present after all of the set of flash only illuminated images of the surface are captured.

Clause 44

The method according to one of clauses 22, 23, 24, 25, 26, 27, 28, 29, 30, 31, 32, 33, 34, 35, 36, 37, 38, 39, 40, 41, 42, or 43, wherein inspecting the inspectable images to determine whether the set of inconsistencies are present after all of the set of flash only illuminated images of the surface are captured comprises:
automatically inspecting, by a machine learning model, the inspectable images captured by the image capture system to determine whether the set of inconsistencies are present after all of the set of flash only illuminated images of the surface are captured.

Clause 45

The method according to one of clauses 20, 21, 22, 23, 24, 25, 26, 27, 28, 29, 30, 31, 32, 33, 34, 35, 36, 37, 38, 39, 40, 41, 42, 43, or 44 further comprising:
placing a flag such that the flag blocks a reflection of the set of synchronized flashes from further reflecting off of another surface and back into the area on the surface being inspected.

Clause 46

The method according to one of clauses 20, 21, 22, 23, 24, 25, 26, 27, 28, 29, 30, 31, 32, 33, 34, 35, 36, 37, 38, 39, 40, 41, 42, 43, 44, or 45 further comprising:
emitting groups of synchronized flashes from the set of strobe lights one group at a time, wherein the image capture system captures an image each time a group of synchronized flashes is emitted.

Clause 47

The method according to one of clauses 20, 21, 22, 23, 24, 25, 26, 27, 28, 29, 30, 31, 32, 33, 34, 35, 36, 37, 38, 39, 40, 41, 42, 43, 44, 45, or 46 further comprising:
increasing an inspection range by increasing a strobe power for the set of strobe lights.

Clause 48

The method according to one of clauses 20, 21, 22, 23, 24, 25, 26, 27, 28, 29, 30, 31, 32, 33, 34, 35, 36, 37, 38, 39, 40, 41, 42, 43, 44, 45, 46, or 47, wherein capturing, by the image capture system, the set of flash only illuminated images of the surface illuminated by the set of flashes comprises:
capturing, by the image capture system, a set of the set of flash only illuminated images of the surface illuminated by the set of synchronized flashes without ambient light in which the image capture system captures the set of images in a position perpendicular to the area of the surface.

Clause 49

A method for inspecting a surface of an aircraft fuselage of an aircraft, the method comprising:
aligning a set of strobe lights in a strobe light system to emit synchronized flashes at an area of the surface of the aircraft fuselage, wherein the area has a width that is at least at a multiple or fraction of a frame pitch;
progressively capturing, by an image capture system, images of the surface for successive areas relative to the frame pitch; and
inspecting the images captured by the image capture system.

Clause 50

The method according to clause 49, wherein inspecting the images captured by the image capture system comprises:
inspecting the images captured by the image capture system to determine whether a set of inconsistencies are present within the images.

Clause 51

The method according to one of clauses 49 or 50, wherein the strobe light system and the image capture system form a surface inspection system and further comprising:
pulsing the surface inspection system relative to the aircraft fuselage such that the synchronized flashes are progressively emitted at successive areas between frames in the aircraft fuselage.

Clause 52

The method according to one of clauses 49, 50, or 51 further comprising:
moving the aircraft fuselage such that the synchronized flashes are progressively emitted at successive areas between frames in the aircraft fuselage.

Clause 53

The method according to one of clauses 49, 50, 51, or 52 further comprising:
emitting the synchronized flashes with an angle of incidence relative to the surface of the aircraft fuselage, wherein the angle of incidence is selected based on a type of inconsistency to be detected.

Clause 54

The method according to one of clauses 49, 50, 51, 52, or 53, wherein the area has a height of the aircraft fuselage a half barrel, and a full barrel of the aircraft fuselage.

Clause 55

A method for inspecting a surface of an object, the method comprising:
emitting a set of synchronized flashes at an area on the surface at an angle of incidence relative to the surface;
capturing, by an image capture system, a set of flash only illuminated images of the area on the surface illuminated only by the set of synchronized flashes emitted at the area on the surface at the angle of incidence; and
inspecting the set of flash only illuminated images of the area on the surface captured by the image capture system to determine whether an inconsistency is present in the area on the surface.

Clause 56

The method according to clause 55, wherein emitting the set of synchronized flashes at the area on the surface at the angle of incidence relative to the surface comprises:
emitting the set of synchronized flashes from a strobe light system at the area on the surface at the angle of incidence relative to the surface.

Clause 57

The method according to one of clauses 55 or 56, wherein emitting the set of synchronized flashes at the area on the surface at the angle of incidence relative to the surface comprises:
emitting the set of synchronized flashes from a strobe light system at the area on the surface at the angle of incidence relative to the surface, wherein the angle of incidence is selected based on a type of inconsistency to be detected.

Clause 58

The method according to one of clauses 55, 56, or 57, wherein emitting the set of synchronized flashes at the area on the surface at the angle of incidence relative to the surface comprises:
emitting the set of synchronized flashes from a strobe light system at the area on the surface at a set of various angles of incidence relative to the surface in addition to the angle of incidence, wherein the set of various angles of incidence includes the angle of incidence.

Clause 59

The method according to clause 58, wherein emitting the set of synchronized flashes from the strobe light system at the set of various angles of incidence relative to the surface in addition to the angle of incidence relative to the surface comprises:
emitting a first number of the synchronized flashes in the set of synchronized flashes at a first angle of incidence relative to the surface; and
emitting a second number of synchronized flashes in the set of synchronized flashes from the strobe light system at a second angle of incidence relative to the surface.

Clause 60

The method according to one of clauses 55, 56, 57, 58, or 59, wherein emitting the set of synchronized flashes at the area on the surface at the angle of incidence relative to the surface comprises:
emitting the set of synchronized flashes at the area on the surface at the angle of incidence relative to the surface, wherein the angle of incidence is from about 60 degrees to about 80 degrees.

Clause 61

The method according to one of clauses 55, 56, 57, 58, 59, or 60, wherein emitting the set of synchronized flashes at the area on the surface at the angle of incidence relative to the surface comprises:
emitting the set of synchronized flashes at the area on the surface at the angle of incidence relative to the surface, wherein the angle of incidence selected decreases as a size of the inconsistency to be detected increases.

Clause 62

The method according to one of clauses 55, 56, 57, 58, 59, 60, or 61, wherein emitting the set of synchronized flashes at the area on the surface at the angle of incidence relative to the surface comprise:
emitting a first number of the synchronized flashes in the set of synchronized flashes at the angle of incidence relative to the surface; and
emitting a second number of synchronized flashes in the set of synchronized flashes at the angle of incidence relative to the surface after emitting the first number of synchronized flashes.

Clause 63

The method according to one of clauses 55, 56, 57, 58, 59, 60, 61, or 62, wherein the emitting the set of synchronized flashes at the area on the surface at the angle of incidence relative to the surface comprises:
emitting a first number of the synchronized flashes in the set of synchronized flashes at the area on the surface at the angle of incidence relative to the surface from a first location, wherein the image capture system captures a first image in the set of images of the area illuminated by the first number of synchronized flashes; and
emitting a second number of synchronized flashes in the set of synchronized flashes at the area on the surface at the angle of incidence relative to the surface from a second location, wherein the image capture system captures a second image in the set of images of the area illuminated by the first number of synchronized flashes;
wherein capturing, by the image capture system, the set of flash only illuminated images of the area on the surface illuminated only by the set of synchronized flashes emitted at the area on the surface at the angle of incidence comprises:
capturing, by the image capture system, a first image in the set of images of the area on the surface that is only illuminated by the first number of synchronized flashes emitted at the area on the surface at the angle of incidence; and
capturing, by the image capture system, a second image in the set of flash only illuminated images of the area on the surface illuminated only by the second number of synchronized flashes emitted at the area on the surface at the angle of incidence.

Clause 64

The method according to one of clauses 55, 56, 57, 58, 59, 60, 61, 62, or 63, wherein the surface of the object is a curved surface and wherein emitting the set of synchronized flashes at the area on the surface at the angle of incidence relative to the surface comprises:
emitting the set of synchronized flashes from a set of locations at the area on the surface at an angle of incidence relative to the surface in which the set of synchronized flashes are emitted at the area in a direction that is parallel to a line of inflection on which the curved surface curves.

Clause 65

The method according to one of clauses 55, 56, 57, 58, 59, 60, 61, 62, 63, or 64, wherein capturing, by the image capture system, the set of flash only illuminated images of the area on the surface illuminated only by the set of synchronized flashes emitted at the area on the surface at the angle of incidence comprises:
capturing, by the image capture system, the set of flash only illuminated images of the area on the surface illuminated only by the set of synchronized flashes emitted at the area on the surface at the angle of incidence in which the image capture system captures the set of flash only illuminated images from a position perpendicular to the area of the surface.

Clause 66

The method according to one of clauses 55, 56, 57, 58, 59, 60, 61, 62, 63, 64, or 65 further comprising:
setting the image capture system to capture the set of flash only illuminated images using only the set of synchronized flashes.

Clause 67

The method according to clause 66, wherein setting the image capture system to capture the set of flash only illuminated images using only the set of synchronized flashes emitted at the area on the surface at the angle of incidence comprises:
setting at least one of an aperture, a shutter speed, or an ISO such that the image capture system captures the set of images using only the set of synchronized flashes without an ambient light.

Clause 68

The method according to one of clauses 66 or 67, wherein setting the image capture system to capture the set of flash only illuminated images using only the set of synchronized flashes emitted at the area on the surface at the angle of incidence comprises:
setting a shutter speed such that the image capture system captures the set of images using only the set of synchronized flashes without an ambient light.

Clause 69

The method according to one of clauses 66, 67, or 68, wherein setting the image capture system to capture the set of flash only illuminated images using only the set of synchronized flashes emitted at the area on the surface at the angle of incidence comprises:
setting an aperture such that the image capture system captures the set of images using only the set of synchronized flashes without an ambient light.

Clause 70

The method according to one of clauses 66, 67, 68, or 69, wherein setting the image capture system to capture the set of flash only illuminated images using only the set of synchronized flashes emitted at the area on the surface at the angle of incidence comprises:
setting an ISO such that the image capture system captures the set of images using only the set of synchronized flashes without an ambient light.

Clause 71

The method according to one of clauses 66, 67, 68, 69, or 70 further comprising:
capturing a black image without emitting the set of synchronized flashes, wherein the black image verifies the ambient light is not captured by the image capture system.

Clause 72

The method according to one of clauses 55, 56, 57, 58, 59, 60, 61, 62, 63, 64, 65, 66, 67, 68, 69, 70, or 71, wherein capturing, by the image capture system, the set of images of the area on the surface that is only illuminated by the set of synchronized flashes emitted at the area on the surface at the angle of incidence comprises:
capturing, by the image capture system, the set of flash only illuminated images of the area on the surface illuminated only by the set of synchronized flashes emitted at the area on the surface at the angle of incidence in which the image capture system uses a shutter speed that is synchronized within a duration of the set of synchronized flashes in the area such that a strobe light system is an isolated light source.

Clause 73

The method according to one of clauses 55, 56, 57, 58, 59, 60, 61, 62, 63, 64, 65, 66, 67, 68, 69, 70, 71, or 72, placing a flag such that the flag blocks a reflection of the set of synchronized flashes from further reflecting off another surface and back into the area on the surface being inspected.

Clause 74

The method according to one of clauses 55, 56, 57, 58, 59, 60, 61, 62, 63, 64, 65, 66, 67, 68, 69, 70, 71, 72, or 73, wherein capturing, by the image capture system, set of images of the area on the surface that is only illuminated by the set of synchronized flashes emitted at the area on the surface at the angle of incidence comprises:
capturing a first image in the set of flash only illuminated images from a first number of synchronized flashes in the set of synchronized flashes emitted from a strobe light system at the area on the surface at the angle of incidence relative to the surface from a first location; and
capturing a second image in the set of flash only illuminated images from a second number of synchronized flashes in the set of synchronized flashes emitted from the strobe light system at the area on the surface at the angle of incidence relative to the surface from a second location;
wherein inspecting the set of flash only illuminated images of the area on the surface captured by the image capture system to determine whether the inconsistency is present in the area on the surface comprises:
determining a different between corresponding pixels in the first image and the second image such that an inspectable image is formed; and
inspecting the inspectable image to determine whether the inconsistency is present in the area on the surface.

Clause 75

The method according to clause 74, wherein inspecting the inspectable image to determine whether the inconsistency is present in the area on the surface comprises:
inspecting the inspectable image using a machine learning model to determine whether the inconsistency is present in the area on the surface.

Clause 76

The method according to one of clauses 55, 56, 57, 58, 59, 60, 61, 62, 63, 64, 65, 66, 67, 68, 69, 70, 71, 72, 73, 74, or 75, wherein the inconsistency is selected from a group comprising dust, a dent, an inward dent, and outward dent, a protrusion, a crack, debris, a delamination, a missing fastener, a fastener installed out of tolerance.

Clause 77

The method according to one of clauses 55, 56, 57, 58, 59, 60, 61, 62, 63, 64, 65, 66, 67, 68, 69, 70, 71, 72, 73, 74, 75 or 76, wherein a strobe light system and the image capture system are connected to a platform and further comprising:
moving the platform, wherein the strobe light system is positioned to emit the set of synchronized flashes from the strobe light system at a second area on the surface at the angle of incidence relative to the surface and wherein the image capture system is positioned to capture additional flash only illuminated images of the second area;
emitting the set of synchronized flashes from the strobe light system at the second area on the surface at the angle of incidence relative to the surface, wherein the angle of incidence is selected based on a type of inconsistency to be detected;
capturing, by the image capture system, the additional flash only illuminated images of the second area on the surface that is only illuminated by the set of synchronized flashes emitted at the area on the surface at the angle of incidence; and
inspecting the additional flash only illuminated images of the second area on the surface captured by the image capture system to determine whether the inconsistency is present in the second area on the surface.

Clause 78

The method according to one of clauses 55, 56, 57, 58, 59, 60, 61, 62, 63, 64, 65, 66, 67, 68, 69, 70, 71, 72, 73, 74, 75, 76, or 77 further comprising:
moving the object, wherein a strobe light system is positioned to emit the set of synchronized flashes from the strobe light system at a second area on the surface at the angle of incidence relative to the surface and wherein the image capture system is positioned to capture the additional flash only illuminated images of the second area;
emitting the set of synchronized flashes from the strobe light system at the second area on the surface at the angle of incidence relative to the surface, wherein the angle of incidence is selected based on a type of inconsistency to be detected;
capturing, by the image capture system, the additional flash only illuminated images of the second area on the surface that is only illuminated by the set of synchronized flashes emitted at the angle of incidence; and
inspecting the flash only illuminated additional images of the second area on the surface captured by the image capture system to determine whether the inconsistency is present in the second area on the surface.

Clause 79

A surface inspection system comprising:
a strobe light system;
an image capture system; and
a controller configured to:
control the strobe light system to emit a set of synchronized flashes from a strobe light system at an area on the surface at an angle of incidence relative to the surface;
control the image capture system to capture a set of flash only illuminated images of the area on the surface illuminated only by the set of synchronized flashes emitted at the area on the surface at the angle of incidence; and
inspect the set of flash only illuminated images of the area on the surface captured by the image capture system to determine whether an inconsistency is present in the area on the surface.

Clause 80

The surface inspection system according to clause 79 further comprising:
a platform, wherein the strobe light system and the image capture system are connected to the platform.

Clause 81

The surface inspection system according to one of clauses 79 or 80, wherein in controlling the strobe light system to emit the set of synchronized flashes from the strobe light system at the area on the surface at the angle of incidence relative to the surface, controller is configured to:
control the strobe light system to emit the set of synchronized flashes from the strobe light system at the area on the surface at the angle of incidence relative to the surface, wherein the angle of incidence is selected based on a type of inconsistency to be detected.

Clause 82

The surface inspection system according to one of clauses 79, 80, or 81, wherein controlling the strobe light system to emit the set of synchronized flashes from the strobe light system, controller is configured to:
control the strobe light system to emit the set of synchronized flashes at the area on the surface at a set of various angles of incidence relative to the surface in addition to the angle of incidence.

Clause 83

The surface inspection system according to clause 82, wherein in controlling the strobe light system to emit the set of synchronized flashes from the strobe light system at the set of various angles of incidence relative to the surface in addition to the angle of incidence relative to the surface, controller is configured to:
control the strobe light system to emit a first number of the synchronized flashes in the set of synchronized flashes from the strobe light system at a first angle of incidence relative to the surface; and
control the strobe light system to emit a second number of synchronized flashes in the set of synchronized flashes from the strobe light system at a second angle of incidence relative to the surface.

Clause 84

The surface inspection system according to one of clauses 79, 80, 81, 82, or 83, wherein in controlling the strobe light system to emit the set of synchronized flashes from the strobe light system, the controller is configured to:
control the strobe light system to emit the set of synchronized flashes from the strobe light system at the area on the surface at the angle of incidence relative to the surface, wherein the angle of incidence is from about 60 degrees to about 80 degrees.

Clause 85

The surface inspection system according to one of clauses 79, 80, 81, 82, 83, or 84, wherein in controlling the strobe light system to emit the set of synchronized flashes from the strobe light system, the controller is configured to:
control the strobe light system to emit the set of synchronized flashes from the strobe light system at the area on the surface at the angle of incidence relative to the surface, wherein the angle of incidence selected decreases as a size of the inconsistency to be detected increases.

Clause 86

The surface inspection system according to one of clauses 79, 80, 81, 82, 83, 84, or 85, wherein in controlling the strobe light system to emit the set of synchronized flashes from the strobe light system, the controller is configured to:
control the strobe light system to emit a first number of the synchronized flashes in the set of synchronized flashes from the strobe light system at the angle of incidence relative to the surface; and
control the strobe light system to emit a second number of synchronized flashes in the set of synchronized flashes from the strobe light system at the angle of incidence relative to the surface after emitting the first number of synchronized flashes.

Clause 87

The surface inspection system according to one of clauses 79, 80, 81, 82, 83, 84, 85, or 86, wherein controlling the strobe light system to emit the set of synchronized flashes from the strobe light system, the controller is configured to:
control the strobe light system to emit a first number of the synchronized flashes in the set of synchronized flashes from the strobe light system at the area on the surface at the angle of incidence relative to the surface from a first location, wherein the image capture system captures a first image in the set of images of the area illuminated by the first number of synchronized flashes; and
control the strobe light system to emit a second number of synchronized flashes in the set of synchronized flashes from the strobe light system at the area on the surface at the angle of incidence relative to the surface from a second location, wherein the image capture system captures a second image in the set of images of the area illuminated by the first number of synchronized flashes;
wherein in controlling the image capture system to capture the set of flash only illuminated images of the area on the surface illuminated only by the set of synchronized flashes emitted at the area on the surface at the angle of incidence, the controller is configured to:
control the image capture system to capture a first image in the set of images of the area on the surface that is only illuminated by the first number of synchronized flashes emitted at the area on the surface at the angle of incidence; and
control the image capture system to capture a second image in the set of flash only illuminated images of the area on the surface illuminated only by the second number of synchronized flashes emitted at the area on the surface at the angle of incidence.

Clause 88

The surface inspection system according to one of clauses 79, 80, 81, 82, 83, 84, 85, 86, or 87, wherein the surface is a curved surface and wherein in controlling the strobe light system to emit the set of synchronized flashes from the strobe light system at the area on the surface at the angle of incidence relative to the surface, the controller is configured to:
control the strobe light system to emit the set of synchronized flashes from a set of locations at the area on the surface at an angle of incidence relative to the surface in which the set of synchronized flashes are emitted at the area in a direction that is parallel to a line of inflection on which the curved surface curves.

Clause 89

The surface inspection system according to one of clauses 79, 80, 81, 82, 83, 84, 85, 86, 87, or 88, wherein in controlling the image capture system to capture the set of flash only illuminated image of the area on the surface illuminated only by the set of synchronized flashes emitted at the area on the surface at the angle of incidence, the controller is configured to:
control the image capture system to capture the set of flash only illuminated images of the area on the surface illuminated only by the set of synchronized flashes emitted at the area on the surface at the angle of incidence in which the image capture system captures the set of flash only illuminated images from a position perpendicular to the area of the surface.

Clause 90

The surface inspection system according to one of clauses 79, 80, 81, 82, 83, 84, 85, 86, 87, 88, or 89, wherein the controller is configured to:
set the image capture system to capture the set of flash only illuminated images using only the set of synchronized flashes.

Clause 91

The surface inspection system according to clause 90, wherein in setting the image capture system to capture the set of flash only illuminated images using only the set of synchronized flashes emitted at the area on the surface at the angle of incidence, the controller is configured to:
set at least one of an aperture, a shutter speed, or an ISO such that the image capture system captures the set of images using only the set of synchronized flashes without an ambient light.

Clause 92

The surface inspection system according to clause 90, the controller is configured to:
control the image capture system to capture a black image without emitting the set of synchronized flashes, wherein the black image verifies an ambient light is not captured by the image capture system.

Clause 93

The surface inspection system according to one of clauses 79, 80, 81, 82, 83, 84, 85, 86, 87, 88, 89, 90, 91, or 92, wherein controlling the image capture system to capture the set of images of the area on the surface that is only illuminated by the set of synchronized flashes emitted at the area on the surface at the angle of incidence, the controller is configure to:
control the image capture system to capture the set of flash only illuminated images of the area on the surface illuminated only by the set of synchronized flashes emitted at the area on the surface at the angle of incidence in which the image capture system uses a shutter speed that is synchronized within a duration of the strobe light in the area such that the strobe light is an isolated light source.

Clause 94

The surface inspection system according to one of clauses 79, 80, 81, 82, 83, 84, 85, 86, 87, 88, 89, 90, 91, 92, or 93, wherein the controller is configured to:
place a flag such that the flag blocks a reflection of the set of synchronized flashes from further reflecting off another surface and back into the area on the surface being inspected.

Clause 95

The surface inspection system according to one of clauses 79, 80, 81, 82, 83, 84, 85, 86, 87, 88, 89, 90, 91, 92, 93, or 94, wherein controlling the image capture system to capture the set of flash only illuminated images of the area on the surface that is only illuminated by the set of synchronized flashes emitted at the area on the surface at the angle of incidence comprises:
control the image capture system to capture a first image in the set of flash only illuminated images from a first number of synchronized flashes in the set of synchronized flashes emitted from the strobe light system at the area on the surface at the angle of incidence relative to the surface from a first location; and
control the image capture system to capture a second image in the set of flash only illuminated images from a second number of synchronized flashes in the set of synchronized flashes emitted from the strobe light system at the area on the surface at the angle of incidence relative to the surface from a second location;
wherein in inspecting the set of flash only illuminated images of the area on the surface captured by the image capture system to determine whether the inconsistency is present in the area on the surface, the controller is configured to:
determine a difference between corresponding pixels in the first image and the second image such that an inspectable image is formed; and
inspect the inspectable image to determine whether the inconsistency is present in the area on the surface.

Clause 96

The surface inspection system according to clause 95, wherein in inspecting the inspectable image to determine whether the inconsistency is present in the area on the surface, the controller is configured to:
inspect the inspectable image using a machine learning model to determine whether the inconsistency is present in the area on the surface.

Clause 97

The surface inspection system according to one of clauses 79, 80, 81, 82, 83, 84, 85, 86, 87, 88, 89, 90, 91, 92, 93, 94, 95, or 96, wherein the inconsistency is selected from a group comprising dust, a dent, an inward dent, and outward dent, a protrusion, a crack, debris, a delamination, a missing fastener, a fastener installed out of tolerance.

Clause 98

The surface inspection system according to one of clauses 79, 80, 81, 82, 83, 84, 85, 86, 87, 88, 89, 90, 91, 92, 93, 94, 95, 96, or 97, wherein the strobe light system and image capture system are connected to a platform and wherein the controller is configured to:
move the platform, wherein the strobe light system is positioned to emit the set of synchronized flashes from the strobe light system at a second area on the surface at the angle of incidence relative to the surface and wherein the image capture system is positioned to capture additional flash only illuminated images of the second area;
control the strobe light system to emit the set of synchronized flashes from the strobe light system at the second area on the surface at the angle of incidence relative to the surface, wherein the angle of incidence is selected based on a type of inconsistency to be detected;
control the image capture system to capture the additional flash only illuminated images of the second area on the surface that is only illuminated by the set of synchronized flashes emitted at the area on the surface at the angle of incidence; and
inspect the additional flash only illuminated images of the second area on the surface captured by the image capture system to determine whether the inconsistency is present in the second area on the surface.

Clause 99

The surface inspection system according to one of clauses 79, 80, 81, 82, 83, 84, 85, 86, 87, 88, 89, 90, 91, 92, 93, 94, 95, 96, 97, or 98, wherein the controller is configured to:
move an object, wherein the strobe light system is positioned to emit the set of synchronized flashes from the strobe light system at a second area on the surface at the angle of incidence relative to the surface and wherein the image capture system is positioned to capture additional flash only illuminated images of the second area;
control the strobe light system to emit the set of synchronized flashes from the strobe light system at the second area on the surface at the angle of incidence relative to the surface, wherein the angle of incidence is selected based on a type of inconsistency to be detected;
control the image capture system to capture, the additional flash only illuminated images of the second area on the surface that is only illuminated by the set of synchronized flashes emitted at the angle of incidence; and
inspect the flash only illuminated additional images of the second area on the surface captured by the image capture system to determine whether the inconsistency is present in the second area on the surface.

Clause 100

The surface inspection system according to clause 98, wherein the platform is a mobile platform and wherein the platform moves relative to an object such that the strobe light system is positioned to emit the set of synchronized flashes from the strobe light system at second area on the surface at the angle of incidence relative to the surface and wherein the image capture system is positioned to capture additional images of the second area;
wherein the controller controls the strobe light system to emit the set of synchronized flashes from the strobe light system at the second area on the surface at the angle of incidence relative to the surface, wherein the angle of incidence is selected based on a type of inconsistency to be detected and controls the image capture system to capture the additional images of the second area on the surface that is only illuminated by the set of synchronized flashes emitted at the area on the surface at the angle of incidence; and inspects the additional images of the second area on the surface captured by the image capture system to determine whether the inconsistency is present in the area on the surface.

Clause 101

The surface inspection system according to clause 100, wherein inspecting images of the area on the surface captured by the image capture system to determine whether the inconsistency is present in the area on the surface and inspecting the additional images of the second area on the surface captured by the image capture system to determine whether the inconsistency is present in the second area on the surface are performed after capturing the images and capturing the additional images.

Clause 102

The surface inspection system according to one of clauses 79, 80, 81, 82, 83, 84, 85, 86, 87, 88, 89, 90, 91, 92, 93, 94, 95, 96, 97, 98, 99, 100, or 101, wherein the object moves such that the strobe light system is positioned to emit the set of synchronized flashes from the strobe light system at a second area on the surface at the angle of incidence relative to the surface and the image capture system is positioned to capture additional images of the second area;
wherein the set of synchronized flashes is emitted from the strobe light system at the second area on the surface at the angle of incidence relative to the surface, wherein the angle of incidence is selected based on a type of inconsistency to be detected; the image capture system captures additional images of the second area on the surface that is only illuminated by the set of synchronized flashes emitted at the area on the surface at the angle of incidence; and
wherein the controller inspects the additional images of the second area on the surface captured by the image capture system to determine whether the inconsistency is present in the area on the surface.

Clause 103

A surface inspection system comprising:
a strobe light positioned relative to an area on a surface of an object, wherein strobe light emits a flash at the area on a surface of the object at an angle of incidence relative to the surface, wherein the angle of incidence is selected based on a type of inconsistency to be detected; and
an image capture system positioned such that the flash is captured perpendicular to the area, wherein the image capture system captures a flash only illuminated image of the area on the surface that is only illuminated by the flash emitted from the strobe light to the area on the surface at the angle of incidence.

Clause 104

The surface inspection system according to clause 103 further comprising:
a controller that inspects the flash only illuminated image of the area on the surface captured by the image capture system to determine whether the inconsistency is present in the area on the surface.

Clause 105

The surface inspection system according to one of clauses 103 or 104, wherein the strobe light is positioned relative to the area on the surface in a first location further comprising:
a second strobe light is positioned relative to the area on the surface in a second location, wherein the second strobe light emits a second flash at the area on the surface of the object at the angle of incidence relative to the surface, wherein the image capture system captures a second flash only illuminated image of the area on the surface that is only illuminated by the second flash emitted from the second strobe light at the angle of incidence.

Clause 106

The surface inspection system according to clause 105, wherein the first location is 180 degrees from the second location.

Clause 107

The surface inspection system according to one of clauses 103, 104, 105, or 106, wherein the surface is a curved surface and wherein the strobe light is positioned to emit the flash at the area in a direction along a line of inflection that is parallel to a curvature of the curved surface.

Clause 108

The surface inspection system according to one of clauses 103, 104, 105, 106, or 107, wherein the image capture system has a shutter speed that is insufficient to capture an ambient light

Clause 109

The surface inspection system according to one of clauses 103, 104, 105, 106, 107, or 108, wherein the image capture system has a shutter speed that is synchronized within the duration of the flash in the area such that the strobe light is an isolated light source.

Thus, illustrative examples provide a method, apparatus, and system for inspecting services examples, synchronized flashes are emitted from strobe lights at the surface of an object. Images are captured during the illumination of the surface of the object by the synchronized flashes. In the illustrative examples, the synchronized flashes are emitted at an incident angle. The incident angle can be selected based on a particular type of inconsistency to be detected. This incident angle can be from about 60 degrees to 80 degrees.

In some illustrative examples, multiple images can be captured from synchronized flashes being emitted from different locations at an area of the surface. For example, a first set of synchronized flashes can be emitted from a first location at the area. A first image can be captured during the illumination of the area by the first set of synchronized flashes. A second set of synchronized flashes can be emitted from a second location at the area. Second image can be captured during the illumination of the area by the second set of synchronized flashes. These locations can be opposite to each other in some illustrative examples. The first image and the second image can be combined to form an inspectable image for inspection.

As a result, the different illustrative examples can employ one or more angles of incidence when illuminating a surface using a strobe light system. This type of illumination can enable capturing images where the inconsistencies are better highlighted by the incident angled direct and sharp illumination by flashes emitted at one or more angles of incidence. This type of illumination can increase the appearance of shadows that are more defined and make the inconsistencies easier to detect in images.

Additionally, the angle incidence lighting increases the contrast of the image illuminating high points or placing low points in deep shadow, especially when opposing strobe illuminated images are used in a combined image after successive opposite eliminated captured images are combined. By capturing images from flashes emitted at the area from different locations relative to the area being inspected, inconsistencies that do not have a consistent shape can be highlighted and shadowed such that the combination is stronger in one direction than the other. This combination can be made by capturing images from each direction and combining the images to form an inspectable image. As a result, by locating strobe lights in locations such that the flashes are opposing directions, further enhancement of inconsistencies can be achieved when capturing images of the area.

Further, in other illustrative examples one or more locations in addition to the two locations can be used to obtain additional images. These additional images can also be combined with the first image and second image to create the inspectable image for inspection.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, To the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method for inspecting a surface comprising:
adjusting at least one of an aperture or a shutter speed in an image capture system to result in capturing a black image when an image of a surface is captured with the surface illuminated only by an ambient light;
capturing, by the image capture system, an incident angled flash illuminated image of the surface to create a first image;
capturing, by the image capture system, an opposed incident angled flash illuminated image of the surface to create a second image;
combining the first image and the second image to form an inspectable image with a width of at least one frame pitch; and
inspecting the inspectable image.

2. The method of claim 1, wherein adjusting at least one of the aperture or the shutter speed in the image capture system to result in capturing the black image when the image of the surface is captured with the surface illuminated only by the ambient light comprises:
adjusting an image capture system to have of the aperture that is a sufficiently small to result in capturing the black image when the image of the surface is captured with the surface illuminated only by the ambient light.

3. The method of claim 1, wherein adjusting at least one of the aperture or the shutter speed in the image capture system to result in capturing the black image when the image of the surface is captured with the surface illuminated only by the ambient light comprises:
adjusting an image capture system to have the shutter speed that is sufficiently high to result in capturing the black image when the image of the surface is captured with the surface illuminated only by an ambient light.

4. The method of claim 1, wherein inspecting the inspectable image comprises:
inspecting the inspectable image for a set of inconsistencies.

5. The method of claim 1, wherein the surface is for a skin of an aircraft fuselage of an aircraft and further comprising:
advancing the image capture system to the surface of a next frame pitch of the aircraft fuselage; and
repeating the capturing, by the image capture system, the incident angled flash illuminated image of the surface to create the first image for the next frame pitch; capturing, by the image capture system, the opposed incident angled flash illuminated image of the surface to create the second image for the next frame pitch; and combining the first image and the second image to form the inspectable image with a width of at based on a frame pitch for the next frame pitch of the aircraft fuselage.

6. (canceled)

7. The method of claim 1, wherein the surface is for an aircraft fuselage of an aircraft and further comprising:
pulsing the aircraft fuselage such that the image capture system is positioned relative to the surface of a next frame pitch of the aircraft fuselage; and
repeating the capturing, by the image capture system, the incident angled flash illuminated image of the surface to create the first image at the next frame pitch; capturing, by the image capture system, the opposed incident angled flash illuminated image of the surface to create a second image at the next frame pitch; and combining the first image and the second image to form the inspectable image with a width of at least one frame pitch for the next frame pitch of the aircraft fuselage.

8-10. (canceled)

11. The method of claim 1, wherein the surface is for an aircraft fuselage of an aircraft and further comprising:
pulsing the image capture system such that the image capture system is positioned relative to the surface of a next frame pitch of the aircraft fuselage;
repeating the capturing, by the image capture system, the incident angled flash illuminated image of the surface to create the first image at the next frame pitch; capturing, by the image capture system, the opposed incident angled flash illuminated image of the surface to create a second image at the next frame pitch; and combining the first image and the second image to form the inspectable image with a width of at least one frame pitch for the next frame pitch of the aircraft fuselage.

12-16. (canceled)

17. The method of claim 1, wherein capturing, by the image capture system, the incident angled flash illuminated image of the surface to create the first image and capturing, by the image capture system, the opposed incident angled flash illuminated image of the surface to create the second image comprises:
capturing, by the image capture system, the incident angled flash illuminated image of the surface to create the first image and capturing, by the image capture system, the opposed incident angled flash illuminated image of the surface to create the second image, wherein the first image and the second image each have a width that is one of a multiple of the frame pitch and a fraction of the frame pitch.

18. The method of claim 1, wherein capturing, by the image capture system, the incident angled flash illuminated image of the surface to create the first image and capturing, by the image capture system, the opposed incident angled flash illuminated image of the surface to create the second image are part of capturing a set of incident angled flash illuminated images of the surface to create first images of a circumference of a barrel section for an aircraft fuselage and a set of opposed incident angled flash illuminated image of the surface to create second image of the circumference of a barrel section for the aircraft fuselage, wherein each first image and each second image is captured by a set of cameras in the image capture system.

19. (canceled)

20. A method for inspecting a surface of an object, the method comprising:
aligning a set of strobe lights to emit a set of flashes at a set of angles of incidence relative to the surface to be inspected;
setting an image capture system to capture flash only illuminated images of an area on the surface illuminated by a set of synchronized flashes emitted at the area on the surface with the set angles of incidence by the set of strobe lights;
capturing, by the image capture system, a set of flash only illuminated images of the surface illuminated by the set of flashes; and
creating an inspectable image using the set of flash only illuminated images.

21-34. (canceled)

35. The method of claim 20 further comprising:
combining a first image and a second image into an inspectable image; and
inspecting the inspectable image for inconsistencies that are out of tolerance.

36-41. (canceled)

42. The method of claim 20, wherein the set of strobe lights and the image capture system form a surface inspection system and further comprising:
moving the surface inspection system parallel to a line of inflection relative to the surface to be inspected.

43-45. (canceled)

46. The method of claim 20 further comprising:
emitting groups of synchronized flashes from the set of strobe lights one group at a time, wherein the image capture system captures an image each time a group of synchronized flashes is emitted.

47-48. (canceled)

49. A method for inspecting a surface of an aircraft fuselage of an aircraft, the method comprising:
aligning a set of strobe lights in a strobe light system to emit synchronized flashes at an area of the surface of the aircraft fuselage, wherein the area has a width that is at least at a multiple or fraction of a frame pitch;
progressively capturing, by an image capture system, images of the surface for successive areas relative to the frame pitch; and
inspecting the images captured by the image capture system.

50. (canceled)

51. The method of claim 49, wherein the strobe light system and the image capture system form a surface inspection system and further comprising:
pulsing the surface inspection system relative to the aircraft fuselage such that the synchronized flashes are progressively emitted at successive areas between frames in the aircraft fuselage.

52. The method of claim 49 further comprising:
moving the aircraft fuselage such that the synchronized flashes are progressively emitted at successive areas between frames in the aircraft fuselage.

53. The method of claim 49 further comprising:
emitting the synchronized flashes with an angle of incidence relative to the surface of the aircraft fuselage, wherein the angle of incidence is selected based on a type of inconsistency to be detected.

54. (canceled)

55. A method for inspecting a surface of an object, the method comprising:
emitting a set of synchronized flashes at an area on the surface at an angle of incidence relative to the surface;
capturing, by an image capture system, a set of flash only illuminated images of the area on the surface illuminated only by the set of synchronized flashes emitted at the area on the surface at the angle of incidence; and
inspecting the set of flash only illuminated images of the area on the surface captured by the image capture system to determine whether an inconsistency is present in the area on the surface.

56-73. (canceled)

74. The method of claim 55, wherein capturing, by the image capture system, set of images of the area on the surface that is only illuminated by the set of synchronized flashes emitted at the area on the surface at the angle of incidence comprises:
capturing a first image in the set of flash only illuminated images from a first number of synchronized flashes in the set of synchronized flashes emitted from a strobe light system at the area on the surface at the angle of incidence relative to the surface from a first location; and
capturing a second image in the set of flash only illuminated images from a second number of synchronized flashes in the set of synchronized flashes emitted from the strobe light system at the area on the surface at the angle of incidence relative to the surface from a second location;
wherein inspecting the set of flash only illuminated images of the area on the surface captured by the image capture system to determine whether the inconsistency is present in the area on the surface comprises:
determining a different between corresponding pixels in the first image and the second image such that an inspectable image is formed; and
inspecting the inspectable image to determine whether the inconsistency is present in the area on the surface.

75-76. (canceled)

77. The method of claim 55, wherein a strobe light system and the image capture system are connected to a platform and further comprising:
moving the platform, wherein the strobe light system is positioned to emit the set of synchronized flashes from the strobe light system at a second area on the surface at the angle of incidence relative to the surface and wherein the image capture system is positioned to capture additional flash only illuminated images of the second area;
emitting the set of synchronized flashes from the strobe light system at the second area on the surface at the angle of incidence relative to the surface, wherein the angle of incidence is selected based on a type of inconsistency to be detected;
capturing, by the image capture system, the additional flash only illuminated images of the second area on the surface that is only illuminated by the set of synchronized flashes emitted at the area on the surface at the angle of incidence; and
inspecting the additional flash only illuminated images of the second area on the surface captured by the image capture system to determine whether the inconsistency is present in the second area on the surface.

78. The method of claim 55 further comprising:
moving the object, wherein a strobe light system is positioned to emit the set of synchronized flashes from the strobe light system at a second area on the surface at the angle of incidence relative to the surface and wherein the image capture system is positioned to capture additional flash only illuminated images of the second area;
emitting the set of synchronized flashes from the strobe light system at the second area on the surface at the angle of incidence relative to the surface, wherein the angle of incidence is selected based on a type of inconsistency to be detected;
capturing, by the image capture system, the additional flash only illuminated images of the second area on the surface that is only illuminated by the set of synchronized flashes emitted at the angle of incidence; and
inspecting the flash only illuminated additional images of the second area on the surface captured by the image capture system to determine whether the inconsistency is present in the second area on the surface.

79. A surface inspection system comprising:
a strobe light system;
an image capture system; and
a controller configured to:
control the strobe light system to emit a set of synchronized flashes from a strobe light system at an area on a surface at an angle of incidence relative to the surface;
control the image capture system to capture a set of flash only illuminated images of the area on the surface illuminated only by the set of synchronized flashes emitted at the area on the surface at the angle of incidence; and
inspect the set of flash only illuminated images of the area on the surface captured by the image capture system to determine whether an inconsistency is present in the area on the surface.

80-84. (canceled)

85. The surface inspection system of claim 79, wherein in controlling the strobe light system to emit the set of synchronized flashes from the strobe light system, the controller is configured to:
control the strobe light system to emit the set of synchronized flashes from the strobe light system at the area on the surface at the angle of incidence relative to the surface, wherein the angle of incidence selected decreases as a size of the inconsistency to be detected increases.

86. (canceled)

87. The surface inspection system of claim 79, wherein controlling the strobe light system to emit the set of synchronized flashes from the strobe light system, the controller is configured to:
control the strobe light system to emit a first number of the synchronized flashes in the set of synchronized flashes from the strobe light system at the area on the surface at the angle of incidence relative to the surface from a first location, wherein the image capture system captures a first image in the set of images of the area illuminated by the first number of synchronized flashes; and
control the strobe light system to emit a second number of synchronized flashes in the set of synchronized flashes from the strobe light system at the area on the surface at the angle of incidence relative to the surface from a second location, wherein the image capture system captures a second image in the set of images of the area illuminated by the first number of synchronized flashes;
wherein in controlling the image capture system to capture the set of flash only illuminated images of the area on the surface illuminated only by the set of synchronized flashes emitted at the area on the surface at the angle of incidence, the controller is configured to:
control the image capture system to capture a first image in the set of images of the area on the surface that is only illuminated by the first number of synchronized flashes emitted at the area on the surface at the angle of incidence; and
control the image capture system to capture a second image in the set of flash only illuminated images of the area on the surface illuminated only by the second number of synchronized flashes emitted at the area on the surface at the angle of incidence.

88-94. (canceled)

95. The surface inspection system of claim 79, wherein controlling the image capture system to capture the set of flash only illuminated images of the area on the surface that is only illuminated by the set of synchronized flashes emitted at the area on the surface at the angle of incidence comprises:
control the image capture system to capture a first image in the set of flash only illuminated images from a first number of synchronized flashes in the set of synchronized flashes emitted from the strobe light system at the area on the surface at the angle of incidence relative to the surface from a first location; and
control the image capture system to capture a second image in the set of flash only illuminated images from a second number of synchronized flashes in the set of synchronized flashes emitted from the strobe light system at the area on the surface at the angle of incidence relative to the surface from a second location;
wherein in inspecting the set of flash only illuminated images of the area on the surface captured by the image capture system to determine whether the inconsistency is present in the area on the surface, the controller is configured to:
determine a difference between corresponding pixels in the first image and the second image such that an inspectable image is formed; and
inspect the inspectable image to determine whether the inconsistency is present in the area on the surface.

96-97. (canceled)

98. The surface inspection system of claim 79, wherein the strobe light system and image capture system are connected to a platform and wherein the controller is configured to:
move the platform, wherein the strobe light system is positioned to emit the set of synchronized flashes from the strobe light system at a second area on the surface at the angle of incidence relative to the surface and wherein the image capture system is positioned to capture additional flash only illuminated images of the second area;
control the strobe light system to emit the set of synchronized flashes from the strobe light system at the second area on the surface at the angle of incidence relative to the surface, wherein the angle of incidence is selected based on a type of inconsistency to be detected;
control the image capture system to capture the additional flash only illuminated images of the second area on the surface that is only illuminated by the set of synchronized flashes emitted at the area on the surface at the angle of incidence; and
inspect the additional flash only illuminated images of the second area on the surface captured by the image capture system to determine whether the inconsistency is present in the second area on the surface.

99. The surface inspection system of claim 79, wherein the controller is configured to:
move an object, wherein the strobe light system is positioned to emit the set of synchronized flashes from the strobe light system at a second area on the surface at the angle of incidence relative to the surface and wherein the image capture system is positioned to capture additional flash only illuminated images of the second area;
control the strobe light system to emit the set of synchronized flashes from the strobe light system at the second area on the surface at the angle of incidence relative to the surface, wherein the angle of incidence is selected based on a type of inconsistency to be detected;
control the image capture system to capture, the additional flash only illuminated images of the second area on the surface that is only illuminated by the set of synchronized flashes emitted at the angle of incidence; and
inspect the flash only illuminated additional images of the second area on the surface captured by the image capture system to determine whether the inconsistency is present in the second area on the surface.

100. The surface inspection system of claim 98, wherein the platform is a mobile platform and wherein the platform moves relative to an object such that the strobe light system is positioned to emit the set of synchronized flashes from the strobe light system at second area on the surface at the angle of incidence relative to the surface and wherein the image capture system is positioned to capture additional images of the second area;
wherein the controller controls the strobe light system to emit the set of synchronized flashes from the strobe light system at the second area on the surface at the angle of incidence relative to the surface, wherein the angle of incidence is selected based on a type of inconsistency to be detected and controls the image capture system to capture the additional images of the second area on the surface that is only illuminated by the set of synchronized flashes emitted at the area on the surface at the angle of incidence; and inspects the additional images of the second area on the surface captured by the image capture system to determine whether the inconsistency is present in the area on the surface.

101-102. (canceled)

103. A surface inspection system comprising:
a strobe light positioned relative to an area on a surface of an object, wherein strobe light emits a flash at the area on a surface of the object at an angle of incidence relative to the surface, wherein the angle of incidence is selected based on a type of inconsistency to be detected; and
an image capture system positioned such that the flash is captured perpendicular to the area, wherein the image capture system captures a flash only illuminated image of the area on the surface that is only illuminated by the flash emitted from the strobe light to the area on the surface at the angle of incidence.

104. The surface inspection system of claim 103 further comprising:
a controller that inspects the flash only illuminated image of the area on the surface captured by the image capture system to determine whether the inconsistency is present in the area on the surface.

105-109. (canceled)
